(19) United States
(12) Patent Application Publication
(10) Pub. No.: US 2013/0052434 A1
(43) Pub. Date: Feb. 28, 2013

(54) ANTISTATIC HARD COAT LAYER FORMING COMPOSITION, OPTICAL FILM, OPTICAL FILM MANUFACTURING METHOD, POLARIZATION PLATE, AND IMAGE DISPLAY DEVICE

(71) Applicants: Miho ASAHI, Kanagawa (JP); Kenichi FUKUDA, Kanagawa (JP); Daiki WAKIZAKA, Kanagawa (JP)

(72) Inventors: Miho ASAHI, Kanagawa (JP); Kenichi FUKUDA, Kanagawa (JP); Daiki WAKIZAKA, Kanagawa (JP)

(73) Assignee: FUJIFILM CORPORATION, Tokyo (JP)

(21) Appl. No.: 13/600,026

(22) Filed: Aug. 30, 2012

(30) Foreign Application Priority Data
Aug. 31, 2011 (JP) 2011-190171
Mar. 19, 2012 (JP) 2012-062739
Apr. 27, 2012 (JP) 2012-104199
Aug. 21, 2012 (JP) 2012-182687

(51) Int. Cl. H01B 1/12; B32B 27/30; B32B 23/20; B05D 5/06; B32B 9/04; B32B 7/02

(52) U.S. Cl. 428/212; 428/411.1; 428/532; 427/164; 252/500; 428/500

(57) ABSTRACT

Providing is an antistatic hard-coat-layer forming composition including a nonvolatile component containing a conductive polymer (a) a compound (b) and a photo-polymerization initiator (c); and a volatile component containing a solvent (d) having a hydroxyl group, and a solvent (e) having no hydroxyl group where the boiling point is 120° C. or less, wherein the solvent (d) contains a solvent (d2) with 4 or more carbon atoms having a hydroxyl group where the boiling point is 90° C. or more and the SP value is 22.0 to 35.0, the proportion of the polymer (a) in the nonvolatile component is 1 to 20 mass %, the proportion of the solvent (d) in the volatile component is 0.5 to 25 mass %, and the proportion of the component (d2) in the component (d) is 80 to 100 mass %.

### BACKGROUND OF THE INVENTION

1. Field of the Invention

The present invention relates to an antistatic hard coat layer forming composition, an optical film, an optical film manufacturing method, a polarization plate, and an image display device.

2. Description of the Related Art

In an image display device such as a cathode ray tube (CRT) display device, a plasma display panel (PDP), an electroluminescent display (ELD), a vacuum fluorescent display (VFD), a field emission display (FED), and a liquid crystal display (LCD), it is appropriate to provide an optical film which has antistatic properties and hard coating properties in order to prevent a reduction in visual recognition due to scratching or the attachment of dust or the like on a display surface.

In order to obtain an optical film which has antistatic properties and hard coating properties, the forming of an antistatic hard coat layer using a coating composition, which contains a compound (for example, a conductive polymer) with conductivity which is an antistatic agent, a compound with a polymerizable group which is a binder, and a solvent, on a transparent base material is known.

In general, the using of a combination of an appropriate solvent such as an alcohol (normally, methanol or ethanol) in the coating composition in order to dissolve the compound having conductivity is known (JP2009-263567A).

### SUMMARY OF THE INVENTION

However, as in JP2009-263567A, there is a problem that the antistatic function is lowered when the compound having conductivity is dissolved in an appropriate solvent such as methanol or ethanol and coated. Although the cause of this is not clear, it is assumed that it is because, due to the appropriate solvent coordinating the compound having conductivity, the distance between the compounds having conductivity is lengthened since the compound having conductivity is mixed too uniformly with the binder and ion conducting and electron conducting is not made excellently.

Therefore, the present inventors have newly understood that pimple defects are generated due to the compound having conductivity and the binder aggressively separating after drying, during the manufacturing and coating of the coating solution using a small amount of the appropriate solvent such as methanol, and the surface state of the antistatic layer deteriorates. Here, the pimple defects indicate abnormal portions with a concave shape which can be visually recognized as a bright spot on a coating film which is flat and uniform and is generated due to various causes such as raw materials being mixed during film manufacturing, generation of an aggregate which is derived from instability of the materials, and the attachment of particles or dust. The major axis when the film surface is observed is often approximately several tens of μm to several mm and this is a critical problem with regard to the increased level of demands with regard to the surface state due to the wide spread use of tablet PCs in recent years.

In addition, if a considerable amount of the compound having conductivity is used, since the distance of the compound having conductivity is shorter even when a small amount of the appropriate solvent is used, the deterioration in the antistatic function can be reduced, but there is a problem in that the hardness of the film is lost.

The object of the present invention is to provide an antistatic hard coat layer forming composition which can form an antistatic hard coat layer with superior antistatic properties and film hardness and with few pimple defects.

Another object of the present invention is to provide an optical film which has an antistatic hard coat layer with superior antistatic properties and film hardness and with few pimple defects.

Yet another object of the present invention is to provide a manufacturing method of the optical film, a polarization plate where the optical film is used as a polarization plate protection film, and an image display device which has the optical film or the polarization plate.

The present inventors have intensively studied a solution to the problems and discovered that the problems can be solved.

An antistatic hard coat layer forming composition of the present invention contains a nonvolatile component which contains

(a) a conductive polymer where the weight average molecular weight is 20,000 to 500,000,

(b) a compound which has no hydroxyl group and has two or more photo-polymerizable groups, and

(c) a photo-polymerization initiator, and a volatile component which contains

(d) a solvent which has a hydroxyl group, and

(e) a solvent having no hydroxyl group where the boiling point is 120° C. or less,

wherein the solvent (d) which has a hydroxyl group contains a solvent (d2) with 4 or more carbon atoms having a hydroxyl group where the boiling point is 90° C. or more and the SP value is 22.0 ([(J/cm³)^{1/2}] below in the same manner) or more and 35.0 or less,

a proportion of the conductive polymer (a) in the nonvolatile component of the composition is 1 to 20 mass %, and

a proportion of the solvent (d) in the volatile component of the composition is 0.5 to 25 mass %, and a proportion of the solvent (d2) in the solvent (d) is 80 to 100 mass %.

The antistatic hard coat layer forming composition where the solvent (d2) is a secondary alcohol or a tertiary alcohol is preferable.

In addition, preferably, the solvent (d2) is a solvent which has a carbonyl group.

In addition, preferably, the solvent (d2) is a diacetone alcohol.

In addition, preferably, the conductive polymer (a) is an ion-conducting polymer

In addition, preferably, the conductive polymer (a) is a quaternary ammonium salt-containing polymer.

In addition, preferably, the proportion of the compound (b) in the nonvolatile component of the composition is 60 mass % or more.

In addition, preferably, the proportion of the solvent (e) in the volatile component of the composition is 40 mass % or more.

In addition, preferably, the concentration of the nonvolatile component of the composition is 40 mass % or more.

In addition, preferably, a poly ethylene oxide compound (f) which has one or more photo-polymerizable groups, has no hydroxyl group, and has a —(CH₂CH₂O)ₖ— structure (k represents a number of 1 to 50) wherein the proportion of the compound (f) in the nonvolatile component of the composition is 1 to 20 mass %.

An optical film of the present invention has an antistatic hard coat layer which is formed from the antistatic hard coat layer forming composition of the present invention on a transparent base material.

Preferably, the optical film further comprises a low refractive index layer on the antistatic hard coat layer where a refractive index of the low refractive index layer is lower than that of the antistatic hard coat layer.

In addition, preferably, the transparent base material is a cellulose acylate film.

In addition, preferably, the transparent base material is a (meth)acrylic-based resin film.

A polarization plate of the present invention using the optical film of the present invention as a polarization plate protection film.

An image display device of the present invention has the optical film of the present invention or the polarization plate of the present invention.

An optical film manufacturing method of the present invention comprises forming an antistatic hard coat layer by coating the antistatic hard coat layer forming composition of the present invention on a transparent base material and curing the coated composition.

According to the present invention, it is possible to provide an antistatic hard coat layer forming composition which can form an antistatic hard coat layer with superior antistatic properties and hardness and with few pimple defects.

In addition, according to the present invention, it is possible to provide an optical film which has an antistatic hard coat layer with superior antistatic properties and hardness and with few pimple defects.

In addition, according to the present invention, it is possible to provide a manufacturing method of the optical film, a polarization plate where the optical film is used as a polarization plate protection film, and an image display device which has the optical film or the polarization plate.

Furthermore, according to the present invention, it is possible to provide an antistatic hard coat layer forming composition which can form an optical film which suppresses interference roughness and surface roughness in addition to excellent antistatic properties, excellent hardness, and few pimple defects.

The surface roughness indicate drying roughness which are caused by differences in the solvent drying speed and wind roughness which are thickness roughness which are caused by the drying wind. In wet coating which uses a solvent, it is easy for surface roughness to occur as it is extremely difficult to maintain the solvent drying environment immediately after coating (temperature, humidity and solvent drying speed at the surface) to be constant.

In addition, interference roughness indicate roughness where reflected light has coloring due to interference of reflected light from the boundary of the base material and the hard coat layer and the reflected light of the surface of the hard coat layer when the hard coat layer is laminated on a film base material such as cellulose acylate and where a change in color can be seen which corresponds to film thickness roughness of the hard coat layer.

Since the outer appearance of the image display device is damaged due to the surface roughness and the interference roughness, a reduction of the roughness is desirable.

### DESCRIPTION OF THE PREFERRED EMBODIMENTS

Below, an embodiment of the present invention will be described in detail, but the present invention is not limited thereto. Here, in the specifications, in a case where a numerical value represents a physical value or a characteristic value, a description of [(numerical value 1) to (numerical value 2)] represents the meaning of [(numerical value 1) or more and (numerical value 2) or less]. In addition, in the specifications, a description of “(meth)acrylate” represents the meaning of “at least any of an acrylate or a methacrylate”. “(Meth)acrylic acid”, “(meth)acryloyl”, and the like are the same.

Here, a “repeating unit which is equivalent to a monomer” and a “repeating unit which is derived from a monomer” in the present invention has a meaning of the component which are obtained after the polymerization of a monomer is a repeating unit.

The present invention relates to the following antistatic hard coat layer forming composition.

The antistatic hard coat layer forming composition contains a nonvolatile component which contains

(a) a conductive polymer where the weight average molecular weight is 20,000 to 500,000,

(b) a compound which has no hydroxyl group and has two or more photo-polymerizable groups, and

(c) a photo-polymerization initiator, and a volatile component which contains

(d) a solvent which has a hydroxyl group, and

(e) a solvent having no hydroxyl group where the boiling point is 120° C. or less,

wherein the solvent (d) which has a hydroxyl group contains a solvent (d2) with 4 or more carbon atoms having a hydroxyl group where the boiling point is 90° C. or more and the SP value is 22.0 or more and 35.0 or less,

the proportion of the conductive polymer (a) in the nonvolatile component of the composition is 1 to 20 mass %, and

the proportion of the solvent (d) which has a hydroxyl group in the volatile component of the composition is 0.5 to 25 mass %, the proportion of the component (d2) in the component (d) is 80 to 100 mass %.

(a) Conductive Polymer with Weight Average Molecular Weight of 20,000 to 500,000

The antistatic hard coat layer forming composition of the present invention (referred to below simply as the “hard coat layer forming composition” or the “composition”) contains (a) a conductive polymer where the weight average molecular weight is 20,000 to 500,000 (referred to below simply as “conductive polymer”).

The conductive polymer (a) which is contained in the antistatic hard coat layer forming composition may be one type or may be two or more types.

Examples of the conductive polymer (a) which is used in the present invention include an ion-conducting compound (ion-conducting polymer) or an electron-conducting compound (electron-conducting polymer), and an ion-conducting polymer is preferable from the point that bleeding out is more difficult than a monomer or a surfactant type of compound, the point that solubility in a general organic solvent is high, and the point of view of superior antistatic properties.

(a.1) Ion-Conducting Compound

Examples of the ion-conducting compound include a cationic or an anionic ion-conducting compound, an amphoteric ion-conducting compound, or the like.

Out of these, a cationic or an amphoteric ion-conducting compound which is easily able to obtain the effect of the present invention is preferable, and in particular, a polymer (cationic compound) which has a quaternary ammonium salt group is appropriate from the point of view of high antistatic functionality of the compound.

As the quaternary ammonium salt group containing polymer, any of a low molecular weight type or a high molecular weight type can be used, but a high molecular weight type cationic-based antistatic agent is more preferably used since there is no change in antistatic properties due to bleeding out and the like.

A high molecular weight type of the cationic compound which has a quaternary ammonium salt group can be appropriately selected and used from known compounds, but a quaternary ammonium salt group containing polymer is preferable from the point of view of ion conductance and a polymer which has at least one unit of a structural unit represented by the following general formulae (I) to (III).

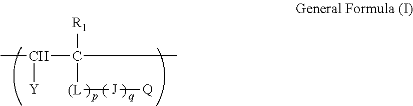

In the general formula (I), R₁ represents a hydrogen atom, an alkyl group, a halogen atom, or —CH₂COO⁻M⁺. Y represents a hydrogen atom or —COO⁻M⁺. M⁺ represents a proton or a cation. L represents —CONH—, —COO—, —CO—, or —O—. J represents an alkylene group, an arylene group, or a group which is a combination of these. Q represents a group which is selected from the following group A.

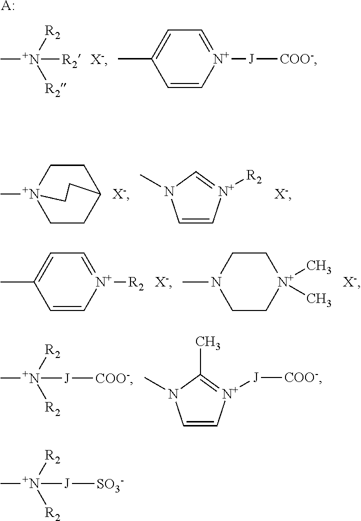

In the formulae, R₂, R₂′, and R₂″ each independently represent an alkyl group. J represents an alkylene group, an arylene group, or a group which is a combination of these. X⁻ represents an anion. p and q each independently represent 0 or 1.

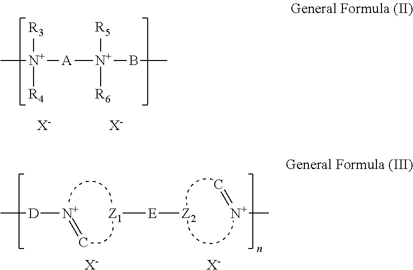

In the general formulae (II) and (III), R₃, R₄, R₅, and R₆ each independently represent an alkyl group and R₃ with R₄ and R₅ with R₆ may form a nitrogen-containing hetero ring by bonding to each other.

A, B, and D each independently represent an alkylene group, an arylene group, an alkenylene group, an arylene alkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, or —R₂₃NHCONHR₂₄NHCONHR₂₅—. E represents a single bond, an alkylene group, an arylene group, an alkenylene group, an arylene alkylene group, —R₇COR₈—, —R₉COOR₁₀OCOR₁₁—, —R₁₂OCR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅—, or —NHCOR₂₆CONH—. R₇, R₈, R₉, R₁₁, R₁₂, R₁₄, R₁₅, R₁₆, R₁₇, R₁₉, R₂₀, R₂₂, R₂₃, R₂₅, and R₂₆ represent an alkylene group. R₁₀, R₁₃, R₁₈, R₂₁, and R₂₄ each independently represent a linking group selected from an alkylene group, an alkenylene group, an arylene group, an arylene alkylene group, and an alkylene arylene group. m represents a positive integer of 1 to 4. X⁻ represents an anion.

Z₁ and Z₂ represent a non-metal atomic group which is necessary to form a 5-membered ring or a 6-membered ring along with —N═C— group and may bond with E with a quaternary salt shape which is ≡N⁺[X].

n represents an integer of 5 to 300.

The groups of the general formulae (I) to (III) will be described.

Examples of the halogen atom include a chlorine atom and a bromine atom and a chlorine atom is preferable.

The alkyl group is preferably a branched or linear chain alkyl group with 1 to 4 carbon atoms and is more preferably a methyl group, an ethyl group, or a propyl group.

The alkylene group is preferably an alkylene group with 1 to 12 carbon atoms, is more preferably a methylene group, an ethylene group, or a propylene group, and is particularly preferably an ethylene group.

The arylene group is preferably an arylene group with 6 to 15 carbon atoms, is more preferably phenylene, diphenylene, a phenyl methylene group, a phenyl dimethylene group, or a naphthylene group, is particularly a phenyl methylene group, and these groups may have a substituent.

The alkenylene group is preferably an alkylene group with 2 to 10 carbon atoms, the arylene alkylene group is preferably an arylene alkylene group with 6 to 12 carbon atoms, and these groups may have a substituent.

Examples of the substituent which may be substituted in each group include a methyl group, an ethyl group, a propyl group, or the like.

In the general formula (I), R₁ is preferably a hydrogen atom.

Y is preferably a hydrogen atom.

J is preferably a phenyl methylene group.

Q is preferably the following general formula (VI) selected from the group A and R₂, R₂′, and R₂″ are each methyl groups.

Examples of X⁻ include a halogen ion, a sulfonate anion, carboxylate anion, or the like, is preferably a halogen ion, and is more preferably a chlorine ion.

p and q are preferably 0 or 1 and more preferably p=0 and q=1.

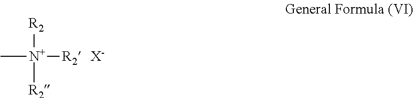

In the general formulae (II) and (III), R₃, R₄, R₅, and R₆ is preferably a substituted or unsubstituted alkyl group with 1 to 4 carbon atoms, is more preferably a methyl group or an ethyl group, and is particularly preferably a methyl group.

A, B, and D preferably each independently represent a substituted or unsubstituted alkylene group, arylene group, alkenylene group, or arylene alkylene group with 2 to 10 carbon atoms, and are more preferably a phenyl dimethylene group.

Examples of X⁻ include a halogen ion, a sulfonate anion, carboxylate anion, or the like, a halogen ion is preferable, and a chlorine ion is more preferable.

E preferably represents a single bond, an alkylene group, an arylene group an alkenylene group, or an arylene alkylene group

The 5-membered ring or 6-membered ring which is formed by Z₁ and Z₂ along with —N═C— group can be exemplified by a diazo niabicyclo octane ring or the like.

Below, specific examples of the compound which has the unit with the structure represent by the general formulae (I) to (III), but the present invention is not limited thereto. Here, in the subscripts in the specific examples below (m, x, y, r, and the actual numerical values), m represents the repeating units of each unit and x, y, and r represent the molar ratios of each of the units.

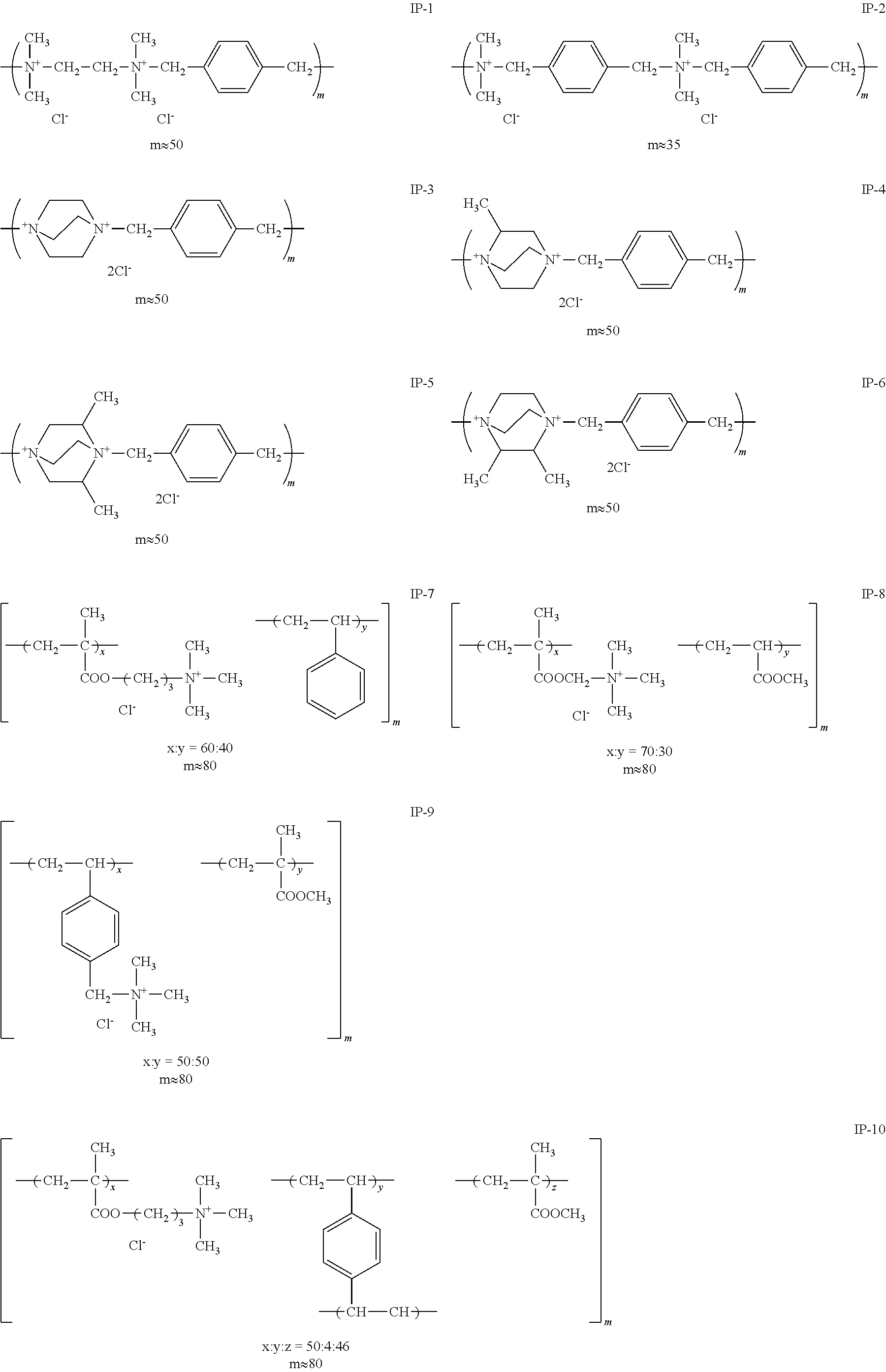

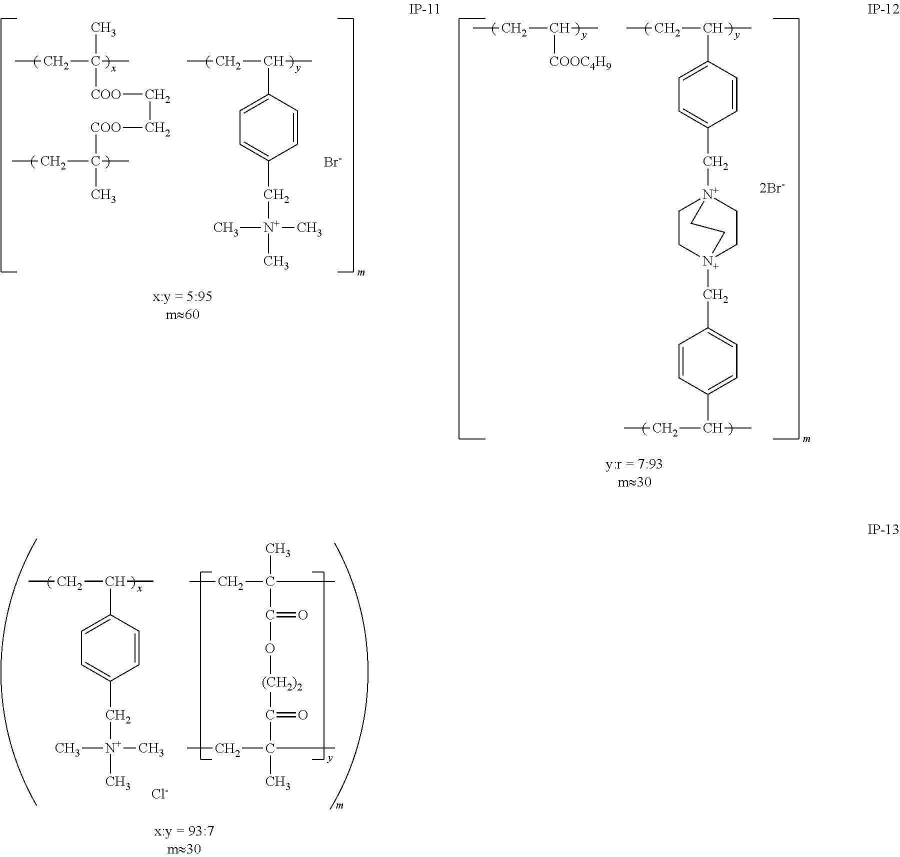

The conductive polymer which is exemplified by the above may be used singly or a compound with two or more types in combination can be used. In addition, the antistatic compound which has a polymerizable group in the molecule of the antistatic agent is more preferable since it can increase the scratch resistance (film strength) of the antistatic layer.

A commercially available product can be used as the ion-conducting compound, and examples thereof include product name “Lioduras LAS-1211” (manufactured by Toyo Ink Co., Ltd.), “Shiko UV-AS-102” (manufactured by Nippon Synthetic Chemical Industry Co., Ltd), “FJ-00101AS”, “FJ-00102AS” (manufactured by Nippon Kasei Chemical Co., Ltd.), and “ASC-209P” (manufactured by Kyoeisha Chemical Co., Ltd.).

The quaternary ammonium salt-containing polymer which is used as the ion-conducting compound may have a polymerizable unit other than the structural units (ionic structural units) represented by the general formulae (I) to (III).

Examples of a monomer which can be used as the polymerizable unit other than the ionic structural unit include the following compounds.

Compound having Alkylene Oxide Chain (a-2)

Due to the ion-conducting compound having the structural unit other than the ionic structural unit, the solubility in a solvent when the composition is formed and the compatibility with a compound which has an unsaturated double bond and the photo-polymerization initiator can be increased. In particular, the ion-conducting compound has an alkylene oxide chain.

A compound (a-2) which has an alkylene oxide chain is represented by the following general formula (2), and for example, can be obtained by an ester exchange reaction with methyl(meth)acrylate or a reaction with chloride(meth)acrylate after ring-opening polymerization of ethylene oxide using alkyl alcohol.

CH₂═C(R⁵)COO(AO)ₙR⁶ (2)

(in the formula, R⁵ represents H or CH₃, R⁶ represents hydrogen or a hydrocarbon group with 1 to 22 carbon atoms, n represents an integer of 2 to 200, and A represents an alkylene group with 2 to 4 carbon atoms.)

In the general formula (2), the alkylene oxide group (AO) is a alkylene oxide group with 2 to 4 carbon atoms, and examples thereof include an ethylene oxide group, a propylene oxide group, and a butylene oxide group. In addition, alkylene oxide groups with different numbers of carbon atoms may exist in the same monomer.

The number of alkylene oxide group (n) is an integer of 2 to 200 and preferably is an integer of 10 to 100. When the number of alkylene oxide group (n) is in the range, the compound having alkylene oxide chain (a-2) is sufficiently compatible with a compound having unsaturated double bonds which will be described later.

R⁶ is hydrogen or a hydrocarbon group with 1 to 22 carbon atoms. It is not practical to have 23 or more carbon atoms as the materials are expensive.

As the hydrocarbon group with 1 to 22 carbon atoms, a substituted or unsubstituted group can be selected, an unsubstituted group is preferable, an unsubstituted alkyl group is preferable, and as an unsubstituted alkyl group, either a branched group or an unbranched group can be used. There may be two or more types used in combination.

Specific examples of the compound (a-2) which has an alkylene oxide chain include polyethylene glycol mono(meth)acrylate, polypropylene glycol mono(meth)acrylate, polybutylene glycol mono(meth)acrylate, poly(ethylene glycol-propylene glycol)mono(meth)acrylate, poly(ethylene glycol-tetramethylene glycol)mono(meth)acrylate, poly(propylene glycol-tetramethylene glycol)mono(meth)acrylate, polyethylene glycol mono(meth)acrylate monomethyl ether, polyethylene glycol mono(meth)acrylate mono butyl ether, polyethylene glycol mono(meth)acrylate mono octyl ether, polyethylene glycol mono(meth)acrylate mono-benzyl ether, polyethylene glycol mono(meth)acrylate mono phenyl ether, polyethylene glycol mono(meth)acrylate mono decyl ether, polyethylene glycol mono(meth)acrylate mono dodecyl ether, polyethylene glycol mono(meth)acrylate mono tetradecyl ether, polyethylene glycol mono(meth)acrylate mono hexadecyl ether, polyethylene glycol mono(meth)acrylate mono octadecyl ether poly(ethylene glycol-propylene glycol)mono(meth)acrylate octyl ether, poly(ethylene glycol-propylene glycol)mono(meth)acrylate octadecyl ether, poly(ethylene glycol-propylene glycol)mono(meth)acrylate nonyl phenyl ether, and the like.

Compound (a-3) copolymerizable with Compound (a-2)

Furthermore, a compound (a-3) which is copolymerizable with an arbitrary with the compound (a-2) may be radical copolymerized as required.

The compound (a-3) which is copolymerizable with the compound (a-2) may be a compound with one ethylenic unsaturated group and is not particularly limited, and examples thereof include alkyl(meth)acrylate such as methyl(meth)acrylate, ethyl(meth)acrylate, propyl(meth)acrylate, butyl(meth)acrylate, 2-ethylhexyl(meth)acrylate, dodecyl(meth)acrylate, octadecyl(meth)acrylate; hydroxyalkyl(meth)acrylate such as hydroxyethyl(meth)acrylate, hydroxypropyl(meth)acrylate, hydroxybutyl(meth)acrylate; various types of (meth)acrylate such as benzyl(meth)acrylate, cyclohexyl(meth)acrylate, isobornyl(meth)acrylate, dicyclopentenyl(meth)acrylate, dicyclopentenyloxyethyl(meth)acrylate, ethoxyethyl(meth)acrylate, ethyl carbitol(meth)acrylate, butoxyethyl(meth)acrylate, cyanoethyl(meth)acrylate, glycidyl(meth)acrylate; styrene, methyl styrene, and the like.

(a.2) Electron-conducting Compound

Examples of the electron-conducting compound include a compound which is a non-conjugated polymer or a conjugated polymer where an aromatic carbon ring or an aromatic hetero ring is linked with a single bond or a linking group which is divalent or more (referred to below as “electron-conducting polymer”). The electron-conducting compound is preferably a polymer which expresses conductivity of 10⁻⁶ S·cm⁻¹ or more and is more preferably a polymer which expresses conductivity of 10⁻¹ S·cm⁻¹ or more.

The electron-conducting compound is preferably a non-conjugated polymer or a conjugated polymer where an aromatic carbon ring or an aromatic hetero ring is linked with a single bond or a linking group which is divalent or more. An example of the aromatic carbon ring in the non-conjugated polymer or the conjugated polymer is a benzene ring and may further form a condensed ring. Examples of the aromatic hetero ring in the non-conjugated polymer or the conjugated polymer include a pyridine ring, a piradine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, an penzo imidazole ring, an imidazopyridine ring, and the like, may further be formed to be a condensed ring, and may have a substituent.

In addition, examples of the linking group which is divalent or more in the non-conjugated polymer or the conjugated polymer include linking groups which are formed from a carbon atom, a nitrogen atom, a silicon atom, a boron atom, an oxygen atom, a sulfur atom, a metal, a metal ion, and the like. A group formed from a carbon atom, a nitrogen atom, a silicon atom, a boron atom, an oxygen atom, a sulfur atom, or a combination of these atoms is preferable, and examples of the group which is formed from a combination of these atoms include a substituted or unsubstituted methylene group, carbonyl group, imino group, sulfonyl group, sulfinyl group, ester group, amide group, silyl group, and the like.

Examples of the electron-conducting polymer specifically include a substituted or unsubstituted conductive polyaniline, polyparaphenylene, polyparaphenylene vinylene, polythiophene, polyfuran, polypyrrole, polyselenophen, polyisothianaphthene, polyphenylene sulfide, polyacetylene, poly pyridyl vinylene, polyazine, derivatives thereof, and the like. This may be used as only one type or two or more types may be combined and used according to the application.

In addition, in a range in which the desired conductivity is able to be achieved, a mixture of other polymer which does not have conductivity can be used and a copolymer with a monomer which configures the electron-conducting polymer and another monomer which does not have conductivity can be used.

The electron-conducting polymer is even more preferably a conjugated polymer. Examples of the conjugated polymer include polyacetylene, polydiacetylene, poly(paraphenylene), poly fluorene, polyazulene, poly(paraphenylene sulfide), polypyrrole, polythiophene, poly isothianaphthene, polyaniline, poly(paraphenylene vinylene), poly(2,5-thienylene vinylene), double-chain conjugated polymer (such as poly perinaphthalene), metal phthalocyanine polymers, and other conjugated polymer (poly(paraxylylene), poly[α-(5,5′-bithiophenediyl)benzylidene] and the like), derivatives thereof, and the like.

Preferable examples include poly(paraphenylene), polypyrrole, polythiophene, polyaniline, poly(paraphenylene vinylene), and poly(2,5-thienylene vinylene), more preferable examples include polythiophene, polyaniline, polypyrrole, and derivatives thereof, and even more preferable examples include at least any of polythiophene and derivatives thereof.

The conjugated polymer may have a substituent. Examples of the substituent of the conjugated polymer can include a substituent which is described as R¹¹ in the general formula (s1) which will be described later.

In particular, that the electron-conducting polymer has a moiety structure represented by the following general formula (s1) (that is, polythiophene or derivatives thereof) is preferable from the point of view of obtaining an optical film where high transparency and antistatic properties are compatible.

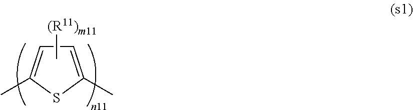

In the general formula (s1), R¹¹ represents a substituent and m11 represents an integer of 0 to 2. When m11 represents 2, a plurality of R¹¹ may be the same or may be different and may form a ring by being connected to each other. n11 represents an integer of 1 or more.

As the substituent represented by R¹¹, examples include an alkyl group (with preferably 1 to 20 carbon atoms, more preferably 1 to 12 carbon atoms, and even more preferably 1 to 8 carbon atoms, and examples thereof include methyl, ethyl, iso-propyl, tert-butyl, n-octyl, n-decyl, n-hexadecyl, cyclopropyl, cyclopentyl, cyclohexyl, and the like), an alkenyl group (with preferably 2 to 20 carbon atoms, more preferably 2 to 12 carbon atoms, and particularly preferably 2 to 8 carbon atoms, and examples thereof include vinyl, allyl, 2-butenyl, 3-pentenyl, 2-hexenyl, 3-hexenyl, 4-hexenyl, 2-octenyl, and the like), an alkynyl group (with preferably 2 to 20 carbon atoms, more preferably 2 to 12 carbon atoms, and particularly preferably 2 to 8 carbon atoms, and examples thereof include propargyl, 3-pentynyl, and the like), an aryl group (with preferably 6 to 30 carbon atoms, more preferably 6 to 20 carbon atoms, and particularly preferably 6 to 12 carbon atoms, and examples thereof include phenyl, p-methyl phenyl, naphthyl, and the like), an amino group (with preferably 0 to 20 carbon atoms, more preferably 0 to 10 carbon atoms, and particularly preferably 0 to 6 carbon atoms, and examples thereof include amino, methylamino, dimethylamino, diethylamino, dibenzylamino, diphenylamino, and the like),

an alkoxy group (with preferably 1 to 20 carbon atoms, more preferably 1 to 12 carbon atoms, and particularly preferably 1 to 8 carbon atoms, and examples thereof include methoxy, ethoxy, butoxy, hexyloxy, octyloxy, and the like), an aryloxy group (with preferably 6 to 20 carbon atoms, more preferably 6 to 16 carbon atoms, and particularly preferably 6 to 12 carbon atoms, and examples thereof include phenyloxy, 2-naphthyloxy, and the like), an acyl group (with preferably 1 to 20 carbon atoms, more preferably 1 to 16 carbon atoms, and particularly preferably 1 to 12 carbon atoms, and examples thereof include acetyl, benzoyl, formyl, pivaloyl, and the like), an alkoxycarbonyl group (with preferably 2 to 20 carbon atoms, more preferably 2 to 16 carbon atoms, and particularly preferably 2 to 12 carbon atoms, and examples thereof include methoxycarbonyl, ethoxycarbonyl, and the like), an aryloxycarbonyl group (with preferably 7 to 20 carbon atoms, more preferably 7 to 16 carbon atoms, and particularly preferably 7 to 10 carbon atoms, and examples thereof include phenyloxycarbonyl and the like),

an acyloxy group (with preferably 2 to 20 carbon atoms, more preferably 2 to 16 carbon atoms, and particularly preferably 2 to 10 carbon atoms, and examples thereof include acetoxy, benzoyloxy, and the like), an acylamino group (with preferably 2 to 20 carbon atoms, more preferably 2 to 16 carbon atoms, and particularly preferably 2 to 10 carbon atoms, and examples thereof include acetylamino, benzoylamino, and the like), an alkoxycarbonylamino group (with preferably 2 to 20 carbon atoms, more preferably 2 to 16 carbon atoms, and particularly preferably 2 to 12 carbon atoms, and examples thereof include methoxycarbonylamino and the like), an aryloxy carbonyl amino (with preferably 7 to 20 carbon atoms, more preferably 7 to 16 carbon atoms, and particularly preferably 7 to 12 carbon atoms, and examples thereof include phenyl oxy carbonyl amino and the like), a sulfonylamino group (with preferably 1 to 20 carbon atoms, more preferably 1 to 16 carbon atoms, and particularly preferably 1 to 12 carbon atoms, and examples thereof include methane sulfonyl amino, benzene sulfonyl amino, and the like), a sulfamoyl group (with preferably 0 to 20 carbon atoms, more preferably 0 to 16 carbon atoms, and particularly preferably 0 to 12 carbon atoms, and examples thereof include sulfamoyl, methyl sulfamoyl, dimethyl sulfamoyl, phenyl sulfamoyl, and the like).

A carbamoyl group (with preferably 1 to 20 carbon atoms, more preferably 1 to 16 carbon atoms, and particularly preferably 1 to 12 carbon atoms, and examples thereof include carbamoyl, methylcarbamoyl, diethylcarbamoyl, phenylcarbamoyl, and the like), an alkylthio group (with preferably 1 to 20 carbon atoms, more preferably 1 to 16 carbon atoms, and particularly preferably 1 to 12 carbon atoms, and examples thereof include methylthio, ethylthio, and the like), an arylthio group (with preferably 6 to 20 carbon atoms, more preferably 6 to 16 carbon atoms, and particularly preferably 6 to 12 carbon atoms, and examples thereof include phenylthio and the like), a sulfonyl group (with preferably 1 to 20 carbon atoms, more preferably 1 to 16 carbon atoms, and particularly preferably 1 to 12 carbon atoms, and examples thereof include mesyl, tosyl, and the like), a sulfinyl group (with preferably 1 to 20 carbon atoms, more preferably 1 to 16 carbon atoms, and particularly preferably 1 to 12 carbon atoms, and examples thereof include methane sulfinyl, benzene sulfinyl, and the like), an ureido group (with preferably 1 to 20 carbon atoms, more preferably 1 to 16 carbon atoms, and particularly preferably 1 to 12 carbon atoms, and examples thereof include ureido, methyl ureido, phenyl ureido, and the like), a phosphate amide group (with preferably 1 to 20 carbon atoms, more preferably 1 to 16 carbon atoms, and particularly preferably 1 to 12 carbon atoms, and examples thereof include diethyl amide phosphate, phenyl amide phosphate, and the like),

a hydroxy group, a mercapto group, a halogen atom (for example, a fluorine atom, a chlorine atom, a bromine atom, and an iodine atom), a cyano group, a sulfo group, carboxyl group, a nitro group, a hydroxamic group, a sulfynol group, a hydrazino group, an imino group, a heterocyclic group (with preferably 1 to 20 carbon atoms and more preferably 1 to 12 carbon atoms, and examples of the hetero atom include a nitrogen atom, an oxygen atom, and a sulfur atom. Specifically, examples thereof include pyrrolidine, piperidine, piperazine, morpholine, thiophene, furan, pyrrole, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetrazaindene, and the like), a silyl group (with preferably 3 to 40 carbon atoms, more preferably 3 to 30 carbon atoms, and particularly preferably 3 to 24 carbon atoms, and examples thereof include trimethylsilyl, triphenylsilyl, and the like), and the like.

The substituent represented by R¹¹ may further be substituted. In addition, in a case where there is a plurality of substituents, these substituents may be the same as each other or may be different and a ring may be formed by bonding in a case where this is possible. Examples of the ring which can be formed include a cycloalkyl ring, a benzene ring, a thiophene ring, a dioxane ring, a dithiane ring, and the like.

The substituent represented by R¹¹ is preferably an alkyl group, an alkenyl group, an alkynyl group, an alkoxy group, or an alkylthio group and is more preferably an alkyl group, an alkoxy group, or an alkylthio group. When m11 is 2, an alkoxy group or an alkylthio group where two R¹¹ form a ring is particularly preferable and the forming of a dioxane ring and a dithiane ring is appropriate.

In the general formula (s1), when m11 is 1, R¹¹ is preferably an alkyl group and is more preferably an alkyl group with 2 to 8 carbon atoms.

In addition, when R¹¹ is poly(3-alkylthiophene) which is an alkyl group, the bonding specifications with the adjacent thiophene rings are regular in a three-dimensional manner with the bonds at all 2-5′ and are irregular in a three-dimensional manner with the bonds at 2-2′ and 5-5′, and being irregular in a three-dimensional manner is preferable.

In the present invention, the electron-conducting polymer is particularly preferably poly(3,4-ethylenedioxy)thiophene (specific example compound (6) described below, PEDOT) from the point of view of compatibility of high transparency and conductivity.

The polythiophene represented in the general formula (s1) and derivatives thereof can be manufactured using a known method such as J. Mater. Chem., 2005, 15, 2077-2088 and Advanced Materials 2000, 12(7), page 481. In addition, as commercially available products, Denatron P502 (manufactured by Nagase ChemteX Corporation), 3,4-ethylenedioxythiophene (BAYTRON (registered trademark) M V2), 3,4-polyethylenedioxythiophene/polystyrenesulfonate (BAYTRON (registered trademark) P), BAYTRON (registered trademark) C, BAYTRON (registered trademark) F E, BAYTRON (registered trademark) P AG, BAYTRON (registered trademark) P HC V4, BAYTRON (registered trademark) P HS, BAYTRON (registered trademark) PH, BAYTRON (registered trademark) PH 500, and BAYTRON (registered trademark) PH 510 (all manufactured by H.C. Starck GmbH.), and the like can be obtained.

As polyaniline and derivatives thereof, polyaniline (manufactured by Sigma-Aldrich Co. LLC.), polyaniline (emeraldine salt) (manufactured by Sigma-Aldrich Co. LLC.), and the like can be obtained.

As polypyrrole and derivatives thereof, polypyrrole (manufactured by Sigma-Aldrich Co. LLC.) and the like can be obtained.

Below, specific examples of the electron-conducting polymer are shown but the present invention is not limited thereto. In the specific example, x and y represent the number of the repeating units. In addition, other than these, examples include the compound described in WO98/01909A and the like.

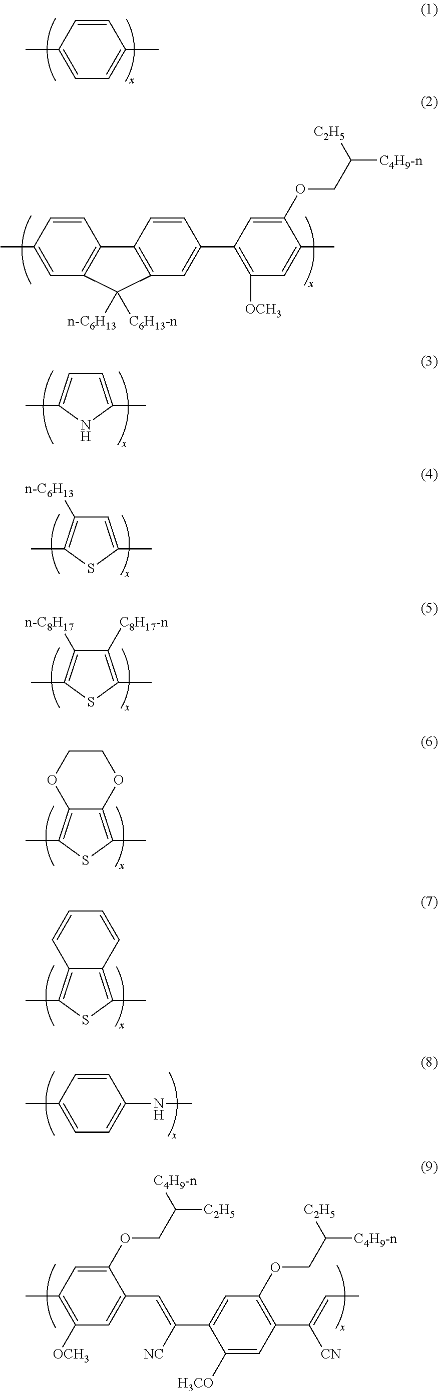

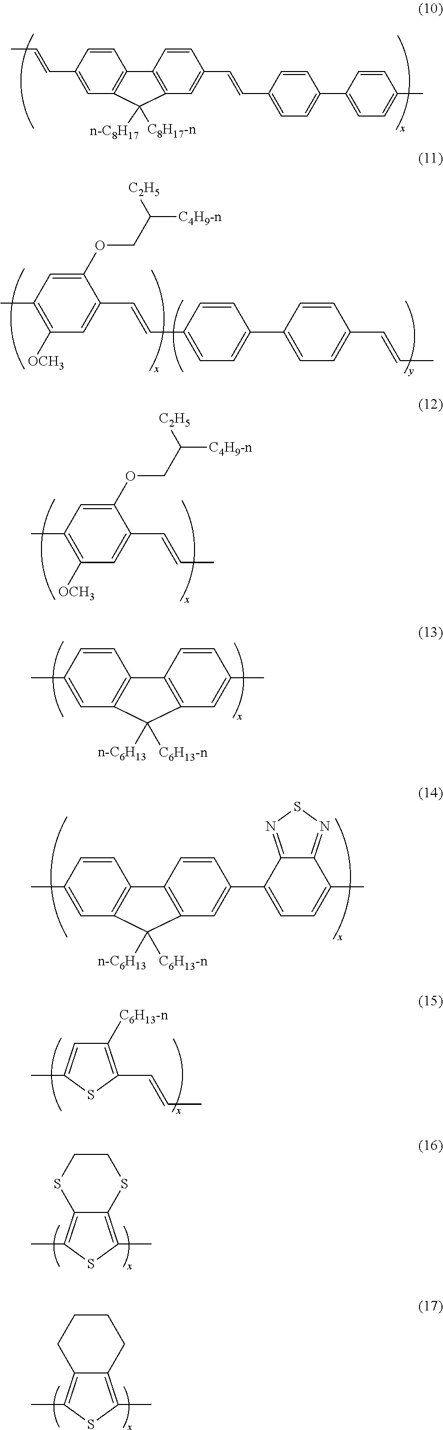

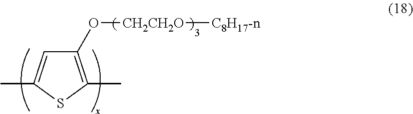

Solubility in Organic Solvent

The electron-conducting polymer is preferably soluble in an organic solvent from the point of view of coating properties and imparting affinity to the component (b).

More specifically, the electron-conducting polymer preferably is soluble to at least 1.0 mass % in an organic solvent where the relative permittivity is 2 to 30 with water content of 5 mass % or less.

Here, “soluble” is being dissolved in a single molecule state or a state where a plurality of single molecules have associated in a solvent, but indicates a state of dispersion in a particle where the particle diameter is 300 nm or less.

Typically, the electron-conducting polymer is highly hydrophilic and is dissolved in a solvent with water as a main component. In the solubility of the electron-conducting polymer in the organic solvent, a method can be used where a compound (for example, a solubility assisting agent or the like which will be described later) which raises the affinity with the organic solvent is added in the composition which includes the electron-conducting polymer or a dispersing agent or the like is added to the organic solvent. In addition, in a case where the electron-conducting polymer and a polyanion dopant is used, the performing of hydrophobic processing of the polyanion dopant as will be described later is preferable.

Furthermore, a method can be used where the solubility of the electron-conducting polymer in the organic solvent is improved in a de-doped state (a state where a dopant is not used) and conductivity is manifested by adding a dopant after the forming of the coating film.

Other than this, the use of a method which is shown in the document below as a method where the solubility in the organic solvent is improved is preferable.

For example, in JP2002-179911A, a method is disclosed where conductivity is manifested by dissolving a polyaniline composition in an organic solvent in a de-doped state, coating the material on a base material, and carrying out oxidation and doping processes with a solution where a protonic acid and an oxidizing agent are dissolved or dispersed after drying.

In addition, in WO05/035626, a method is disclosed where conductive polyaniline which is stably dispersed in an organic solvent is manufactured by a molecular weight adjusting agent and, as required, a phase-transfer catalyst coexist when aniline or derivatives thereof are oxidative-polymerized with the presence of at least one type of a water-insoluble organic polymer compound which has a sulfonic acid and a protonic acid group in a mixing layer formed from a water layer and an organic layer.

As the organic solvent, for example, alcohols, aromatic hydrocarbons, ethers, ketones, esters, and the like are preferable. Below, specific compounds are exemplified (relative permittivity is written in the brackets).

Examples of the alcohols can include a monovalent alcohol or a divalent alcohol. Out of these, as the monovalent alcohol, a saturated aliphatic alcohol with 2 to 8 carbon atoms is preferable. Specific examples of these alcohols can include ethyl alcohol (25.7), n-propyl alcohol (21.8), i-propyl alcohol (18.6), n-butyl alcohol (17.1), sec-butyl alcohol (15.5), tert-butyl alcohol (11.4), and the like.

In addition, specific example of the aromatic hydrocarbons can include benzene (2.3), toluene (2.2), xylene (2.2), and the like, specific examples of the ethers can include tetrahydrofuran (7.5), ethylene glycol monomethyl ether (16), ethylene glycol monomethyl ether acetate (8), ethylene glycol mono ethyl ether (14), ethylene glycol monoethyl ether acetate (8), ethylene glycol monobutyl ether (9), and the like, specific examples of the ketones can include acetone (21.5), diethyl ketone (17.0), methyl ethyl ketone (15.5), diacetone alcohol (18.2), methyl isobutyl ketone (13.1), cyclohexanone (18.3), and the like, and specific examples of the esters include methyl acetate (7.0), ethyl acetate (6.0), propyl acetate (5.7), butyl acetate (5.0), and the like.

The electron-conducting polymer preferably has solubility of at least 1.0 mass % in the organic solvent, more preferably has solubility of at least 1.0 to 10.0 mass %, and even more preferably has solubility of at least 3.0 to 30.0 mass %.

The electron-conducting polymer may exist in a particle state in the organic solvent. In this case, an average particle size of 300 nm or less is preferable, 200 nm or less is more preferable, and 100 nm or less is even more preferable. Precipitation in the organic solvent can be suppressed by setting the particle size as above. The lower limit of the particle size is not particularly limited but 3 nm or more is preferable.

Hydrophobic Processing

In a case where a polyanion dopant is used along with the electron-conducting polymer as described above, performing of hydrophobic processing with regard to the composition which includes the electron-conducting polymer and the polyanion dopant is preferable. By performing hydrophobic processing with regard to the composition, the solubility of the electron-conducting polymer in the organic solvent can be improved and affinity to the compound which has two or more photo-polymerizable groups without the hydroxyl group (b) can be improved by increasing the solubility of the electron-conducting polymer in the organic solvent. The hydrophobic processing can be performed by modifying the anion group of the polyanion dopant.

Specifically, examples of a first method for the hydrophobic processing include the methods of esterification, etherification, acetylation, tosylation, tritylation, alkyl silylation, alkyl carbonylation of the anion group. Out of these, esterification and etherification are preferable. Examples of the hydrophobication method using esterification include a method of chlorination of the anion group of the polyanion dopant using a chlorinating agent followed by esterification using an alcohol such as methanol, ethanol, or the like. Hydrophobication is possible by esterification using a compound which has a hydroxyl group or a glycidyl group and which further has an unsaturated double bond group with a sulfo group or a carboxy group.

In the present invention, various known methods in the related art can be used, and specific examples thereof are disclosed in JP2005-314671A, JP2006-28439A, and the like.

Examples of a second method for the hydrophobic processing include the methods of hydrophobication by bonding a basic compound with the anion group of the polyanion dopant. As the basic compound (basic hydrophobing agent), an amine-based compound is preferable and examples thereof include a primary amine, a secondary amine, a tertiary amine, an aromatic amine, and the like. Specifically, examples thereof include a primary to tertiary amine which is substituted with an alkyl group with 1 to 20 carbon atoms, imidazole, pyridine, and the like which is substituted with an alkyl group with 1 to 20 carbon atoms. The molecular weight of the amine for improving the solubility in the organic solvent is preferably 50 to 2,000, more preferably 70 to 1,000, and most preferably 80 to 500.

The amount of the amine-based compound which is the basic hydrophobing agent is preferably a molar equivalent amount of 0.1 to 10.0 with regard to the anion group of the polyanion dopant which does not contribute to the doping of the electron-conducting polymer, is more preferably a molar equivalent amount of 0.5 to 2.0, and is particularly preferably a molar equivalent amount of 0.85 to 1.25. Due to the range described above, the solubility in the organic solvent, the conductivity, and the strength of the coating film can be satisfied.

With regard to the details of other hydrophobing processes, items disclosed in JP2008-115215A, JP2008-115216A, and the like can be applied.

Solubilization Assisting Agent

The electron-conducting polymer can be used along with a compound (referred to below as a “solubilization assisting agent”) which includes a hydrophilic moiety and a hydrophobic moiety in the molecule, and preferably, a moiety having an ionizing radiation curable functional group.

By using a solubilization assisting agent, the solubilization of the electron-conducting polymer in the organic solvent, where the water content is low, is assisted, and furthermore, improvements in the coating surface and the strength of the curing skin film can be raised in the layer using the composition in the present invention.

The solubilization assisting agent is preferably a copolymer which has a hydrophilic moiety, a hydrophobic moiety, and an ionizing radiation curable functional group containing moiety, and particularly preferably is a copolymer of a block type or a graft type where the moieties are divided into segments. Such a copolymer can be polymerized by living anionic polymerization, living radical polymerization, or by using a macro-monomer which has the moieties described above.

The solubility assisting agent is described, for example, in [0022] to [0038] of JP2006-176681A or the like.

Preparation Method of Solution including Electron-Conducting Polymer

The electron-conducting polymer can be prepared in the state of a solution using the organic solvent.

There are various method as the method for preparing a solution of the electron-conducting polymer, but three examples of preferable methods are included below.

The first method is a method where the electron-conducting polymer is polymerized in water with the presence of a polyanion dopant, after this, there is processing by adding the solubilization assisting agent or the basic hydrophobing agent as required, and replacing the water with the organic solvent after this. The second method is a method where the electron-conducting polymer is polymerized in water with the presence of a polyanion dopant, after this, there is processing by adding the solubilization assisting agent and the basic hydrophobing agent as required, and after evaporating and drying off the water, the organic solvent is added and the mixture is made soluble. The third method is, after a π conjugate conductive polymer and a polyanion dopant are separately prepared, both are mixed and dispersed in a solvent, a conductive polymer composition in a doping state is prepared, and the water is substituted by the organic solvent in a case where the solvent contains water.

In the methods described above, the usage amount of the solubilization assisting agent with regard to the total amount of the electron-conducting polymer and the polyanion dopant is preferably 1 to 100 mass %, is more preferably 2 to 70 mass %, and is most preferably 5 to 50 mass %. In addition, as the method where the water is substituted with the organic solvent in the first method, a method is preferable where, after a uniform solvent is formed using the addition of a solvent with high water miscibility such as ethanol, isopropyl alcohol, and acetone, water is removed by ultrafiltration. In addition, examples thereof include a method where a solvent composition is adjusted by, after the water content is lowered to a certain extent using the solvent with high water miscibility, a more hydrophobic solvent being mixed in and a component with high volatility being removed at low pressure. In addition, if sufficient hydrophobing is performed using the basic hydrophobing agent, the organic conductive polymer in a water phase can be extracted to an organic solvent phase by making two separated phases.

Due to the reasons of improving the antistatic properties and suppressing generation of roughness due to bleeding out, the weight average molecular weight of the ion-conducting compound is 20,000 to 500,000 and is preferably 20,000 to 300,000. The weight average molecular weight of the electron-conducting compound is 20,000 to 500,000, is preferably 20,000 to 300,000, and is more preferably 20,000 to 100,000. Here, the weight average molecular weight is a polystyrene conversion weight average molecular weight which is calculated using a gel permeation chromatography (GPC).

The content of the conductive polymer in the antistatic hard coat layer forming composition of the present invention as the proportion of the nonvolatile component in the antistatic hard coat layer forming composition is 1 to 20 mass %, is preferably 3 to 15 mass %, and is more preferably 5 to 10 mass %. Antistatic properties can be imparted by the content being 1 mass % or more and deterioration in the film hardness does not occur due to the content being 20 mass % or less.

Here, the nonvolatile component of the antistatic hard coat layer forming composition indicates all of the components excluding the solvent in the composition.

Compound (b) Not Having Hydroxyl Group with Two or More Photo-Polymerizable Groups

A compound (b) which has no hydroxyl group and has two or more photo-polymerizable groups (referred to below as a “multifunctional monomer not containing hydroxyl groups”) included in the antistatic hard coat layer forming composition of the present invention will be described.

Since the multifunctional monomer not containing hydroxyl groups (b) forms a resin by being polymerized using light irradiation, a function as a binder is possible in the antistatic hard coat layer. In addition, since the multifunctional monomer not containing hydroxyl groups (b) has two or more photo-polymerizable groups, a function as a hardening agent is possible and the strength of the film and scratch resistance can be improved.

The component (b) does not have a hydroxyl group. When the resin which is the binder has a hydroxyl group, since the hydroxyl group and the conductive polymer (a) strongly interact and both are uniformly mixed, it is considered that this is linked to a reduction in the antistatic properties.

Since the component (b) does not have a hydroxyl group and has two or more photo-polymerizable groups, an antistatic hard coat layer with superior antistatic properties and film hardness can be formed.

As the groups which are photo-polymerizable in the multifunctional monomer not containing hydroxyl groups (b), a group which has a unsaturated double bond is preferable, specifically, examples thereof include a (meth)acryloyl group, a vinyl group, an allyl group, a styryl group, —C(O)OCH═CH₂, and the like, a (meth)acryloyl group and —C(O)OCH═CH₂ are more preferable from the point of view of excellent reactivity with other compounds which have unsaturated double bonds, and a (meth)acryloyl group is even more preferable.

As the number of groups which are photo-polymerizable in the multifunctional monomer not containing hydroxyl groups (b), 10 to 2000 g·mol⁻¹ is preferable, 50 to 1000 g·mol⁻¹ is more preferable, and 100 to 500 g·mol⁻¹ is even more preferable as a functional group equivalent amount from the point of view of suppressing bleeding out and the hardness of the antistatic hard coat layer. As the number of groups which are photo-polymerizable, 2 to 18 is preferable, 2 to 6 is more preferable, and 2 to 4 is even more preferable.

As the multifunctional monomer not containing hydroxyl groups (b), a monomer which forms a polymer with a saturated hydrocarbon chain or a polyether chain as the main chain by polymerization is preferable, and a monomer which forms a polymer with a saturated hydrocarbon chain as the main chain is more preferable.

Examples of the multifunctional monomer not containing hydroxyl groups (b) can include (meth)acrylates diesters of alkylene glycol, (meth)acrylates diesters of polyoxyalkylene glycol, (meth)acrylates diesters of polyhydric alcohol, (meth)acrylates diesters with an ethylene oxide or propylene oxide adduct, epoxy(meth)acrylates, urethane(meth)acrylates, polyester(meth)acrylates, and the like.

Out of these, esters of a polyhydric alcohol and (meth)acrylic acid are preferable. Examples thereof include 1,4-butanediol di(meth)acrylate, 1,6-hexanediol di(meth)acrylate, neopentyl glycol di(meth)acrylate, ethylene glycol di(meth)acrylate, triethylene glycol di(meth)acrylate, pentaerythritol tetra(meth)acrylate, trimethylolpropane tri(meth)acrylate, EO denatured trimethylolpropane tri(meth)acrylate, PO denatured trimethylolpropane tri(meth)acrylate, EO denatured tri-phosphate(meta)acrylate, trimethylol ethane tri(meth)acrylate, ditrimethylolpropane tetra(meth)acrylate, dipentaerythritol hexa(meth)acrylate, pentaerythritol hexa(meth)acrylate, 1,2,3-cyclohexane tetra methacrylate, polyester polyacrylate, caprolactone-denatured tris(acryloxyethyl)isocyanurate, and the like.

As the multifunctional monomer not containing hydroxyl groups (b), a commercially available product can be used. Examples of multifunctional acrylate-based compounds which have a (meth)acryloyl group include KAYARAD DPHA and PET-30 manufactured by Nippon Kayaku Co., Ltd., NK Ester A-TMMT, A-TMPT, A-DPH manufactured by Shin-Nakamura Chemical Co., Ltd, and the like.

The multifunctional acrylate-based compound which has a (meth)acryloyl group is also described in paragraphs [0114] to [0122] in JP2009-98658A.

The multifunctional monomer not containing hydroxyl groups (b) which is included in the antistatic hard coat layer forming composition may be one type or two or more types.

The content of the multifunctional monomer not containing hydroxyl groups (b) in the nonvolatile component of the antistatic hard coat layer forming composition is preferably 60 mass % or more, is more preferably 70 mass % to 97 mass %, and is even more preferably 80 mass % to 95 mass % from the point of view of hardness of the film.

Photo-Polymerization Initiator (c)

A photo-polymerization initiator (c) is contained in the antistatic hard coat layer forming composition.

The photo-polymerization initiator (c) is not particularly limited and examples thereof include acetophenones, benzoin, benzophenones, phosphine oxides, ketals, anthraquinones, thioxanthones, azo compounds, peroxide compounds, 2,3-dialkyl dione compounds, disulfide compounds, fluoroamine compounds, aromatic sulfoniums, lophine dimers, onium salts, borate salts, active esters, active halogens, inorganic complexes, coumarins, and the like. Specific examples, preferable formats, and commercially available products of the photo-polymerization initiator are described in paragraphs [0133] to [0151] in JP2009-098658A and the same can be applied in the present invention. Various examples are also described in “Latest UV Curing Techniques” {Technical Information Institute Co. Ltd.} (1991), p. 159 and “Ultraviolet Curing Systems” by Kiyomi Kato (1989, published by General Technical Center), p. 65 to 148 and are also applicable to the present invention.

The photo-polymerization initiator (c) which is contained in the antistatic hard coat layer forming composition may be one type or may be two or more types.

The content of the photo-polymerization initiator (c) in the antistatic hard coat layer forming composition with regard to the nonvolatile component of the antistatic hard coat layer forming composition is preferably 0.5 to 8 mass % and is more preferably 1 to 5 mass % due to the reasons of setting a sufficient amount so that the compounds able to be polymerized which are included in the antistatic hard coat layer forming composition being polymerized and setting a sufficiently enough amount where the initiating point is not excessively increased.

Solvent (d) Having Hydroxyl Group

A solvent (d) which has a hydroxyl group is contained in the antistatic hard coat layer forming composition. The solvent (d) which has a hydroxyl group is a solvent in the antistatic hard coat layer forming composition.

The proportion of the solvent (d) which has a hydroxyl group in the volatile component of the antistatic hard coat layer forming composition is 0.5 to 25 mass %. Furthermore, the solvent (d) which has a hydroxyl group has a solvent (d2) with 4 or more carbon atoms having a hydroxyl group where the boiling point is 90° C. or more and the SP value is 22.0 or more and 35.0 or less.

The component (d) which is contained in the antistatic hard coat layer forming composition of the present invention may be configured to include only the component (d2).

Solvent (d2) with 4 or more Carbon Atoms having Hydroxyl Group where Boiling Point is 90° C. or more and SP Value is 22.0 or more and 35.0 or less

A solvent (d2) with 4 or more carbon atoms having a hydroxyl group where the boiling point is 90° C. or more and the SP value is 22.0 or more and 35.0 or less (referred to below as “solvent (d2) with 4 or more carbon atoms having a hydroxyl group”) is contained in the antistatic hard coat layer forming composition.

The solvent (d2) with 4 or more carbon atoms having a hydroxyl group is a solvent in the antistatic hard coat layer forming composition and preferably is a solvent where the conductive polymer (a) and the multifunctional monomer not containing hydroxyl groups (b) are appropriately dissolved or dispersed. As described previously, since, when the solvent is a strong appropriate solvent for the conductive polymer (a) such as methanol or ethanol, the appropriate solvent coordinates the conductive polymer (a) and the conductive polymer (a) and the multifunctional monomer not containing hydroxyl groups (b) as a binder are too uniformly mixed, it is considered that the distance between the conductive polymer (a) is lengthened and the antistatic properties are reduced.

The boiling point of the solvent (d2) with 4 or more carbon atoms having a hydroxyl group is 90° C. or more at normal pressure. Since the antistatic hard coat layer forming composition volatilizes too rapidly when drying when the boiling point is less than 90° C., pimple defects are generated since the solubility or the dispersibility is remarkably reduced with regard to the conductive polymer (a) and the multifunctional monomer not containing hydroxyl groups (b) as a binder. The boiling point of the solvent (d2) with 4 or more carbon atoms having a hydroxyl group is preferably 90° C. or more and 190° C. or less, is more preferably 95° C. or more and 180° C. or less, and is even more preferably 100° C. or more and 170° C. or less. If the boiling point is 190° C. or more, drying is easy and the hardness of the film which is obtained is also superior.

The SP value of the solvent (d2) with 4 or more carbon atoms having a hydroxyl group is 22.0 or more and 35.0 or less. When the SP value is less than 22.0 or larger than 35.0, pimple defects are generated since the solubility or the dispersibility is remarkably reduced with regard to the conductive polymer (a) and the multifunctional monomer not containing hydroxyl groups (b) as a binder. The SP value of the solvent (d2) with 4 or more carbon atoms having a hydroxyl group is preferably 22.0 or more and 32.0 or less and is more preferably 22.5 or more and 30.0 or less.

Here, the SP value is a solubility parameter, and in the same manner as polarity which is often used in organic compounds, a larger SP value represents larger polarity. The SP value is able to be calculated using, for example, a Fedor Estimation Method (Basics, Applications, and Calculation Methods of SP Values, p. 66: by Hideki Yamamoto: Joho Kiko Co., Ltd. (published in Mar. 31, 2005).

The number of carbon atoms in the molecule of the solvent (d2) with 4 or more carbon atoms having a hydroxyl group is four or more. Since the coordination with the conductive polymer (a) is easy and the conductive polymer (a) and the multifunctional monomer not containing hydroxyl groups (b) as a binder are too uniformly mixed when the number of carbon atoms is 3 or less, it is considered that the distance between the conductive polymer (a) is lengthened and the antistatic properties are reduced.

The number of carbon atoms in the solvent (d2) with 4 or more carbon atoms having a hydroxyl group is preferably 20 or less, is more preferably 4 or more and 10 or less, and is even more preferably 4 or more and 6 or less from a point of superior handling without the viscosity of the composition rising excessively and further from a point that it is difficult for surface roughness to occur.

As the solvent (d2) with 4 or more carbon atoms having a hydroxyl group, alcohols or phenols with 4 or more carbon atoms which satisfy the conditions of the boiling point and the SP value are preferable, and an alcohol with 4 or more carbon atoms is more preferable from the point of view of handling as a coating solvent and ease of availability.

As an alcohol with 4 or more carbon atoms, a secondary alcohol or a tertiary alcohol is preferable from the point of view of imparting solubility to the conductive polymer and not hindering ion conducting or electron conducting so that the solvent does not strongly coordinate.

The alcohols or phenols with 4 or more carbon atoms as the component (d2) may have a substituent or a characteristic group in the molecule such as an alkyl group, a halogen, an ether bond, a sulfide bond, a thioester bond, a carbonyl group, a formyl group, a phosphino group, an epoxy group, and an amino group.

The component (d2) is preferably configured from only a carbon atom, a hydrogen atom, and an oxygen atom from the point of view of high solubility with regard to the various nonvolatile components such as the compound with conductivity and the multifunctional monomer.

As the solvent with 4 or more carbon atoms, an alcohol which has a carbonyl group in the molecule is preferable, an alcohol which has an acyl group in the molecule is more preferable, and an alcohol which has an aliphatic acyl group is even more preferable due to the reason of superior solubility of the compound with conductivity.

In addition, the valence of the alcohol is preferably 1 to 3 and is more preferably 1.

Examples of the solvent (d2) with 4 or more carbon atoms having a hydroxyl group include 1-butanol (117° C. boiling point, SP value 23.2), 2-butanol (99° C. boiling point, SP value 22.7), 1-pentanol (138° C. boiling point, SP value 22.4), 2-pentanol (138° C. boiling point, SP value 22.4), 3-pentanol (117° C. boiling point, SP value 22.0), 2-methyl-1-butanol (136 to 138° C. boiling point, SP value 24.1), 3-methyl-1-butanol (isopentyl alcohol) (130.5° C. boiling point, SP value 22.0), cyclopentanol (139° C. boiling point, SP value 34.4), cyclohexanol (161° C. boiling point, SP value 34.4), methyl cyclohexanol (155° C. boiling point, SP value 24.4), hexylene glycol (198° C. boiling point, SP value 26.8), tripropylene glycol (192° C. boiling point, SP value 24.7), ethyl cellosolve (2-ethoxy ethanol) (135° C. boiling point, SP value 24.5), isopropyl cellosolve (2-isopropoxy ethanol) (139 to 145° C. boiling point, SP value 23.5), butyl cellosolve (2-butoxyethanol) (168° C. boiling point, SP value 22.1), free fatty acid (FFA) (170° C. boiling point, SP value 32.0), tetrahydrofurfuryl alcohol (THFFA) (178° C. boiling point, SP value 29.2), diethylene glycol (244° C. boiling point, SP value 29.5), dipropylene glycol (232° C. boiling point, SP value 27.1), diethylene glycol monomethyl ether (194° C. boiling point, SP value 22.7), diethylene glycol mono ethyl ether (135° C. boiling point, SP value 22.2), propylene glycol monomethyl ether (120° C. boiling point, SP value 22.7), propylene glycol monoethyl ether (133° C. boiling point, SP value 22.3), diacetone alcohol (166° C. boiling point, SP value 23.9), 3-methoxy -1-propanol (151° C. boiling point, SP value 23.5), o-cresol (191 to 192° C. boiling point, SP value 26.3), and the like.

The solvent (d2) with 4 or more carbon atoms having a hydroxyl group is most preferably a diacetone alcohol. The solvent (d2) with 4 or more carbon atoms having a hydroxyl group which is included in the antistatic hard coat layer forming composition may be one type or may be two or more types.

The proportion of the solvent (d) which has a hydroxyl group including the component (d2) in the volatile component of the antistatic hard coat layer forming composition of the present invention is 0.5 to 25 mass %. When the proportion of the solvent which has a hydroxyl group such as an alcohol exceeds 25 mass % in the volatile component, the compatibility of the antistatic hard coat layer forming composition and the base material (preferably, the base material formed from a cellulose acylate film) deteriorates, the hardness of the film is reduced, and interference roughness occur. In addition, when less than 0.5 mass %, it is difficult to obtain the effect of suppressing the pimple defects.

The proportion of the solvent (d) which has a hydroxyl group including the component (d2) in the volatile component of the antistatic hard coat layer forming composition is preferably 0.5 to 20 mass %, is more preferably 1 to 10 mass %, and is even more preferably 1 to 8 mass %.

Here, the volatile component of the antistatic hard coat layer forming composition indicates all of the solvents.

The proportion of the solvent (d2) with 4 or more carbon atoms having a hydroxyl group in the solvent (d) which has a hydroxyl group such as an alcohol included in the antistatic hard coat layer forming composition in the present invention is 80 to 100 mass %. When the proportion of the solvent (d2) with 4 or more carbon atoms having a hydroxyl group in the solvent (d) which has a hydroxyl group is less than 80 mass %, the effect of the solvent (d2) with 4 or more carbon atoms having a hydroxyl group is not sufficiently obtained, pimple defects occur, and antistatic properties are reduced. The proportion of the solvent (d2) with 4 or more carbon atoms having a hydroxyl group in the solvent (d) which has a hydroxyl group is preferably 90 to 100 mass %, is more preferably 95 to 100 mass %, and is even more preferably 100 mass %.

Solvent (e) Having No Hydroxyl Group where Boiling Point is 120° C. or Less,

A solvent (e) having no hydroxyl group where the boiling point is 120° C. or less (referred to as “solvent (e) not containing hydroxyl groups”) is contained in the antistatic hard coat layer forming composition.

The solvent (e) not containing hydroxyl groups is a solvent in the antistatic hard coat layer forming composition along with the solvent (d2) with 4 or more carbon atoms having a hydroxyl group and has a function where the compound with conductivity, the multifunctional monomer, and the photo-polymerization initiator are uniformly dissolved together and a uniform coating film can be obtained since the solubility of the multifunctional monomer, the photo-polymerization initiator, and the like is high.

The boiling point of the solvent (e) not containing hydroxyl groups is 120° C. or less at normal pressure. When the boiling point exceeds 120° C., it is not preferable since the drying is slow, the antistatic properties and the film hardness deteriorate due to the solvent remaining in the film, and it is easy for surface roughness to occur. The boiling point of the solvent (e) not containing hydroxyl groups is preferably 50° C. to 120° C., is more preferably 55° C. to 110° C., and is even more preferably 60° C. to 100° C.

The solvent (e) not containing hydroxyl groups is not particularly limited as long as it is a solvent other than a solvent which has a hydroxyl group such as alcohols or phenols and has a boiling point of 120° C. or less, and examples thereof include ether-based solvents, ketone-based solvents, aliphatic hydrocarbon-based solvents, aromatic hydrocarbon-based solvents, carbonate-based solvents, ester-based solvents, and the like. Examples thereof include 1,2-dimethoxyethane, 1,2-diethoxy ethane, propylene oxide, 1,4-dioxane, 1,3-dioxolane, 1,3,5-trioxane, tetrahydrofuran, methyl ethyl ketone, methyl isobutyl ketone, diethyl ketone, 2-pentanone, hexane, heptane, methyl cyclohexane, benzene, toluene, dimethyl carbonate, methyl ethyl carbonate, ethyl formate, methyl acetate, ethyl acetate, propyl acetate, methyl propionate, ethyl propionate, acetone, 1,2-diacetoxy acetone, and acetylacetone, and one type singly or two or more types in combination can be used.

The proportion of the solvent (e) not containing hydroxyl groups which is included in the volatile component of the antistatic hard coat layer forming composition is preferably 40 mass % or more, is more preferably 60 mass % or more, and is even more preferably 80 mass % or more due to the reasons that drying is easy and hardness of the film is improved.

The nonvolatile component concentration (solid content concentration) in the antistatic hard coat layer forming composition of the present invention is preferably 40 mass % or more, is more preferably 40 to 75 mass %, and is even more preferably 45 to 70 mass % due to the reasons that it is difficult for surface roughness to occur.

Here, in a region where the nonvolatile component concentration in the composition is low (less than 40 mass %), it is difficult for aggregation to occur and it is difficult for pimple defects to occur since the distance between the conductive polymer and the multifunctional monomer in the composition is long, but in a region where the nonvolatile component concentration is high (40 mass % or more) as is often typically used, the composition is unstable, it is extremely easy for pimple defects to occur, and the problems are remarkable if it is not the composition of the present invention.

As above, the antistatic hard coat layer forming composition of the present invention contains the nonvolatile component which includes the conductive polymer (a) where the weight average molecular weight is 20,000 to 500,000, the compound (b) which has no hydroxyl group and has two or more photo-polymerizable groups, and the photo-polymerization initiator (c), and the volatile component which includes the solvent (d) which has a hydroxyl group, and the solvent (e) having no hydroxyl group where the boiling point is 120° C. or less, where the solvent (d) which has a hydroxyl group contains a solvent (d2) with 4 or more carbon atoms having a hydroxyl group where the boiling point is 90° C. or more and the SP value is 22.0 or more and 35.0 or less, the proportion of the conductive polymer (a) in the nonvolatile component of the composition is 1 to 20 mass %, the proportion of the solvent (d) which has a hydroxyl group in the volatile component of the composition is 0.5 to 25 mass %, and the proportion of the component (d2) in the component (d) is 80 to 100 mass %, but other components may be contained.

Below, other components which the antistatic hard coat layer forming composition may further contain will be described.

Polyethylene Oxide Compound (f)

The antistatic hard coat layer forming composition may contain a polyethylene oxide compound (f) which has at least one group which is photo-polymerizable, does not have a hydroxyl group, and has a —(CH₂CH₂O)ₖ— structure (k represents a number of 1 to 50) (referred to below as “polyethylene oxide compound (f)”).

The polyethylene oxide compound (f) has at least one group which is photo-polymerizable, does not have a hydroxyl group, and has a —(CH₂CH₂O)ₖ— structure (k represents a number of 1 to 50).

Since the compatibility of the polyethylene oxide compound having a group which is photo-polymerizable with the conductive polymer (a) is excellent, the conductive polymer (a) is stretched out and the conductivity remarkably improves. Furthermore, there is an effect where the water retention rate of the hard coat layer is increased and the conductivity of the conductive polymer (a) is increased due to the polyethylene oxide chain of the polyethylene oxide compound (f) bonding to the water in air with hydrogen bonding. As a result, it is possible to realize sufficient conductivity even with a small amount of the conductive polymer (a) and it is possible to form the antistatic hard coat layer with superior conductivity and film hardness.

Furthermore, due to the polyethylene oxide compound (f) not having a hydroxyl group, there is no tendency for a reduction in antistatic properties due to the hydroxyl group and the conductive polymer (a) strongly interacting and it is possible to excellently secure compatibility with the conductive polymer (a) and realize superior antistatic properties.

As the number of group which are photo-polymerizable in the polyethylene oxide compound (f), 10 to 2000 g·mol⁻¹ is preferable, 50 to 1000 g·mol⁻¹ is more preferable, and 100 to 500 g·mol⁻¹ is even more preferable as a functional group equivalent amount from the point of view of the suppression of bleeding out and the hardness of the antistatic hard coat layer not being obstructed. More specifically, as the number of functional groups, 1 to 18 is preferable, 2 to 6 is more preferable, and 2 to 4 is even more preferable.

Examples of the group which are photo-polymerizable in the polyethylene oxide compound (f) include a (meth)acryloyl group, a (meth)acryloyloxy group, a vinyl group, an allyl group, or the like, and a (meth)acryloyloxy group is preferable and an acryloyloxy group is more preferable from the point of view of excellent reactivity with other compound which has an unsaturated double bond.

In the polyethylene oxide compound (f), k represents a repeating number and represents a number of 1 to 50. k is preferably 5 to 30 and is more preferably 7 to 20. When k is 1 or more, the antistatic properties are superior. When k is larger than 50, it is not preferable since the film hardness deteriorates.

A longer polyethylene oxide chain is preferable from the point of view of antistatic properties when compared with the total number of —(CH₂CH₂O)— structures included in one molecule, the number of —(CH₂CH₂O)ₖ— structures which are included in the polyethylene oxide compound (f) is preferably small from the point that it is advantageous for the balance of improving antistatic properties, film hardness, and curling, 6 or less is more preferable, 4 or less is even more preferable, and 1 is particularly preferable.

In addition, the percentage (m2×100/m1) of the formula weight (m2) of the —(CH₂CH₂O)ₖ— structures which take up the molecular weight of the polyethylene oxide compound (f) (ml) is preferably 40% to 90%, is more preferably 50% to 85%, and is even more preferably 60% to 83% from the point of view of improving the antistatic properties.

The molecular weight of the polyethylene oxide compound (f) is preferable 2,000 or less, is more preferably 100 to 1,500, and even more preferably 200 to 1,000. When the molecular weight is 2,000 or less, it is preferable since the hardness of the antistatic hard coat layer is improved and the curling reduction effect is also large. This is considered to be because it is difficult for the polyethylene oxide compound (f) to gather on the surface of the base material when the molecular weight of the polyethylene oxide compound (f) is 2,000 or less.

The polyethylene oxide compound (f) contains the group which is photo-polymerizable and the —(CH₂CH₂O)ₖ— structure, but structures other than these may be included. For example, examples thereof include an alkylene group, an arylene group, an ether bond, a thioether bond, an ester bond, and the like.

The polyethylene oxide compound (f) is preferably formed from the group which is photo-polymerizable and the —(CH₂CH₂O)ₖ— structure due to the reason that it is the easiest manner to realize the antistatic effect.

The polyethylene oxide compound (f) may have a structure with a branched shape or a linear shape, but the compound with a linear shape has a higher effect in terms of improving the antistatic properties when compared with the compound having a structure with a branched shape or a linear shape where the number of (CH₂CH₂O) structures included in one molecule is the same.

As the particularly preferable structure of the polyethylene oxide compound (f), a compound represented by the following general formula (b1) with a structure where groups which are photo-polymerizable bind to both ends of one —(CH₂CH₂O)ₖ— structure.

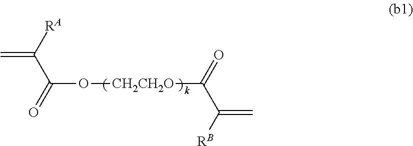

In the general formula, R^{A} and R^{B} each independently represent a hydrogen atom or a methyl group. k is the same as described above and the preferable range is also the same. Among these, k≅9 is most preferable.

Specific examples of the polyethylene oxide compound (f) are shown below but are not limited thereto. Here, ethylene oxide is abbreviated as “EO”.

EO added trimethylolpropane tri(meth)acrylate

EO added pentaerythritol tetra(meth)acrylate

EO added ditrimethylolpropane tetra(meth)acrylate

EO added dipentaerythritol penta(meth)acrylate

EO added dipentaerythritol hexa(meth)acrylate

Tris(2-hydroxyethyl)isocyanurate tri(meth)acrylate

EO denatured diglycerine tetra acrylate

The polyethylene oxide compound (f) can be synthesized using, for example, a method described in JP2001-172307A, JP4506237B, and the like. In addition, a commercially available product can be used as the polyethylene oxide compound (f). Preferable examples of the commercially available product include “NK Ester A-400”, “NK Ester ATM-4E”, and “NK Ester ATM-35E” manufactured by Shin-Nakamura Chemical Co., Ltd., “Blemmer PDE-50”, “Blemmer PE-200”, “Blemmer PDE-200”, “Blemmer PDE-1000”, and “Blemmer PME-4000” manufactured by NOF Corporation, “Viscoat V#360” manufactured by Osaka Organic Chemical Industry Ltd., “DGE-4A” manufactured by Kyoeisha Chemical Co., Ltd., and the like.

In a case where the antistatic hard coat layer forming composition of the present invention contains the polyethylene oxide compound (f), the content of the polyethylene oxide compound (f) in the nonvolatile component of the antistatic hard coat layer forming composition is preferable 1 mass % to 20 mass %, is more preferably 3 mass % to 20 mass %, and is even more preferably 5 mass % to 15 mass % from the point of view of there being a sufficient amount to impart the antistatic properties and it being difficult for film hardness to be reduced.

Compound Having Hydroxyl Group and Two or More Groups Which are Photo-Polymerizable

The antistatic hard coat layer forming composition of the present invention contains the compound (b) which has no hydroxyl group and has two or more photo-polymerizable groups, but may contain a compound which has a hydroxyl group and two or more photo-polymerizable groups in addition to the component (b).

The compound which has a hydroxyl group and has two or more photo-polymerizable groups is the same as the multifunctional monomer not containing hydroxyl group (b) other than having a hydroxyl group and examples thereof include (meth)acrylate diesters of alkylene glycol, (meth)acrylate diesters of polyoxyalkylene glycol, (meth)acrylate diesters of polyhydric alcohol, (meth)acrylate diesters with ethylene oxide or propylene oxide adduct, epoxy(meth)acrylates, urethane(meth)acrylates, polyester(meth)acrylates, and the like.

Out of these, esters of a polyhydric alcohol and (meth)acrylate are preferable. Examples thereof include pentaerythritol tri(meth)acrylate, dipentaerythritol tetra(meth)acrylate, dipentaerythritol penta(meth)acrylate, and the like.

In the case where the antistatic hard coat layer forming composition of the present invention contains the compound which has a hydroxyl group and has two or more photo-polymerizable groups, in the nonvolatile component of the antistatic hard coat layer forming composition, 40 mass % or less is preferable, 30 mass % or less is more preferable, and 20 mass % or less is even more preferable from the point of view of it being difficult to hinder the antistatic properties.

Here, the antistatic hard coat layer forming composition of the present invention preferably does not contain the compound which has a hydroxyl group and has two or more photo-polymerizable groups.

Solvent

The antistatic hard coat layer forming composition of the present invention may contain a solvent other than the solvent (d2) with 4 or more carbon atoms having a hydroxyl group where the boiling point is 90° C. or more and the SP value is 22.0 or more and 35.0 or less and the solvent (e) having no hydroxyl group where the boiling point is 120° C. or less. Examples of the solvents other than the component (d2) and the component (e) include methanol, ethanol, 1-propanol, amyl carbinol, 3-methoxy-3-methyl-1-butanol, ethylene glycol, propylene glycol, 1,2-butanediol, 1,3-butanediol, isopropanol(2-propanol), phenol, 2-methyl-2-propanol(t-butanol), 2-methyl-2-butanol, 2-methyl-2-pentanol, neopentyl alcohol(2,2-dimethyl-1-propanol) 1-hexanol, 4-methyl-2-pentanol, 1-octanol, 2-octanol, α-terpineol(2-(4-methyl cyclohexa-3-enyl)propan-2-ol), polyethylene glycol, methyl cellosolve(2-methoxy ethanol), dipropylene glycol monomethyl ether, dipropylene glycol monoethyl ether, dibutyl ether, anisole, phenetole, diisopropyl ketone, diisobutyl ketone, cyclopentanone, cyclohexanone, 4-methyl cyclohexanone, 2-octanone, 2-hexanone, butyl carbitol(diethylene glycol monobutyl ether), octane, cyclohexane, ethyl cyclohexane, xylene, diethyl carbonate, methyl acetoacetate, ethyl acetoacetate, 2-ethoxy ethyl acetate(ethylene glycol monoethyl ether acetate), acetylacetone, acetic acid 2-methoxyethyl(ethylene glycol monomethyl ether acetate), and the like. In a case where the solvent other than the component (d2) and the component (e) is contained, in the volatile component of the antistatic hard coat layer forming composition, 10 mass % or less is preferable, 5 mass % or less is more preferable, and 2 mass % or less is even more preferable.

Here, the antistatic hard coat layer forming composition of the present invention preferably does not contain the solvent other than the component (d2) and the component (e).

Surfactant

Various types of surfactants may be appropriately used in the antistatic hard coat layer forming composition of the present invention. Typically, a surfactant suppresses film thickness roughness and the like which are caused by variations in drying due to localized distribution of the drying wind and is able to improve an unleveled surface of the antistatic layer and repelling of the coating (functions as a leveling agent). Furthermore, it is appropriate since there is a case where high conductivity can be manifested more stably by improving the dispersion of the antistatic compound.

As the surfactant, specifically, a fluorine-based surfactant or a silicon-based surfactant is preferable. In addition, the surfactant is preferably an oligomer or a polymer more than a low-molecular compound.

When the surfactant is added, since the surfactant is unevenly distributed on the surface of the liquid film which is coated due to moving quickly and the surfactant remains as unevenly distributed on the surface after drying of the film, the surface energy of the antistatic layer where the surfactant is added is reduced due to the surfactant. The surface energy of the film is preferably low from the point of view of preventing non-uniformity in film thickness, repelling, and surface roughness in the antistatic layer.

The preferable format and the specific examples of the fluorine-based surfactant are described in paragraphs [0023] to [0080] of JP2007-102206A and the present invention is the same.

Specific examples of the silicon-based surfactant are surfactants which have a substituent at the end terminal of the compound chain and/or in the side chain where a plurality of dimethyl silyloxy units are included as repeating units. Structural units other than dimethyl silyloxy may be contained in the compound chain which includes dimethyl silyloxy as a repeating unit. The substituent may be the same or may be different and a plurality thereof is preferable. Examples of the preferable substituent include the groups of a polyether group, an alkyl group, an aryl group, an aryloxy group, an aryl group, a cinnamoyl group, an oxetanyl group, a fluoroalkyl group, a polyoxyalkylene group, and the like.

The molecular weight is not particularly limited, but 100,000 or less is preferable, 50,000 or less is more preferable, 1,000 to 30,000 is particularly preferably, and 1,000 to 20,000 is most preferable.

Examples of the preferable silicon-based compound include “X-22-174DX”, “X-22-2426”, “X22-164C”, and “X-22-176D” (all product names) manufactured by Shin-Etsu Chemical Co., Ltd., “FM-7725”, “FM-5521”, and “FM-6621” (all product names) manufactured by Chisso Corporation, “DMS-U22” and “RMS-033” (all product names) manufactured by Gelest, Inc., “SH200”, “DC11PA”, “ST8OPA”, “L7604”, “FZ-2105”, “L-7604”, “Y-7006”, and “SS-2801” (all product names) manufactured by Dow Corning Corporation, “TSF400” (product name) manufactured by Momentive Performance Materials Inc., and the like but are not limited thereto.

The surfactant in the total solid content of the antistatic hard coat layer forming composition is preferably contained to be 0.01 to 0.5 mass % and is more preferably 0.01 to 0.3 mass %.

Translucent Resin Particles

Various types of translucent resin particles can be used for imparting antiglare properties (surface scattering properties) and internal scattering properties in the antistatic hard coat layer of the present invention.

When there is less variation in the particle diameters of translucent resin particles, variation in scattering characteristics are low and design of the haze value is easy. As the translucent resin particles, plastic beads are preferable and it is particularly preferable when the translucency is high and the difference in the refractive index with the binder is the numerical value described below.

As organic particles, poly(methyl methacrylate) particles (refractive index 1.49), cross-linked poly (acrylic-styrene) copolymer particles (refractive index 1.54), melamine resin particles (refractive index 1.57), polycarbonate particles (refractive index 1.57), polystyrene particles (refractive index 1.60), cross-linked polystyrene particle (refractive index 1.61), polyvinyl chloride particle (refractive index 1.60), benzoguanamine-melamine formaldehyde particle (refractive index 1.68), and the like can be used.

Out of these, cross-linked polystyrene particles, cross-linked poly((meth)acrylate) particles, cross-linked poly(acrylic-styrene) particles are preferably used, and it is possible to impart antiglare properties (surface scattering properties) and internal scattering properties by adjusting the refractive index of the binder according to the refractive index of each of the translucent resin particles which are selected from out of these particles. Furthermore, internal haze, surface haze, and center line average roughness can be excellently achieved.

The difference in the refractive indices of the binder and the translucent resin particles which are able to be used in the present invention (refractive index of the translucent resin particles-refractive index of binder) is preferably 0.001 to 0.030 as an absolute value. When the difference in the refractive indices are in this range, there is no problems in terms of film characters being blurred, lowering of the dark room contrast, clouding of the surface, and the like.

The average particle diameter (volumetric standard) of the translucent resin particles is preferably 0.5 to 20 μm. When the average particle diameter is in this range, there is no blurring of characters in the display since the light scattering angle distribution does not become an excessively wide angle.

In addition, two or more types of the translucent resin particles with different particles diameters may be used in combination. Antiglare properties are imparted by the translucent resin particles with a larger particle diameter and the sense of roughness of the surface can be reduced using the translucent resin particles with a smaller particle diameter.

When the translucent resin particles are combined, it is preferable to combine so as to be contained as 3 to 30 mass % in the total solid content of the antistatic hard coat layer. When the content is in this range, problems such as the blurring of the image, clouding of the surface, and dazzling can be prevented and antistatic properties are not lost.

Optical Film

Below, the optical film of the present invention will be described.

The optical film of the present invention has an antistatic hard coat layer which is formed using the antistatic hard coat layer forming composition on a transparent base material.

The optical film of the present invention has the antistatic hard coat layer on the transparent base material and may further have a single or a plurality of functional layers as required according to the application. For example, an anti-reflection layer (a layer where the refractive index is adjusted such as a low refractive index layer, a middle refractive index layer, and a high refractive index layer) or the like may be provided.

Examples of more specific layer configurations of the optical film of the present invention are shown below.

Transparent support/antistatic hard coat layer

Transparent support/antistatic hard coat layer/low refractive index layer

Transparent support/antistatic hard coat layer/high refractive index layer/low refractive index layer

Transparent support/antistatic hard coat layer/middle refractive index layer/high refractive index layer/low refractive index layer

Transparent Base Material

In the optical film of the present invention, various transparent base materials (transparent supports) can be used, but a base material which contains a (meth)acrylic-based resin or a base material which contains a cellulose-based polymer is preferable. As the base material which contains the cellulose-based polymer, a cellulose acylate film is preferably used.

The cellulose acylate film is not particularly limited but a cellulose triacetate film is particularly preferable from the point of productivity and cost since the cellulose triacetate film can be used as it is as a protective film which protects the a polarization layer of the polarization plate in the case of being disposed in a display.

The thickness of the cellulose acylate film is normally approximately 25 μm to 1,000 μm, and is preferably 40 μm to 200 μm where handling is excellent and necessary strength in the base material can be obtained.

In the present invention, it is preferable to use cellulose acetate where the degree of acetylation is 59.0 to 61.5% for the cellulose acylate film. The acetylation degree has the meaning of the amount of binding to acetic acid per unit mass of cellulose. The acetylation degree follows the measurement and the calculation of the acetylation degree in ASTM: D-817-91 (experiment method such as cellulose acetate).

The viscosity average polymerization degree (DP) of the cellulose acylate is preferable 250 or more and is more preferably 290 or more.

In addition, in the cellulose acylate which is used in the present invention, the value of Mw/Mn (Mw is the weight average molecular weight and Mn is the numerical average molecular weight) according to gel permeation chromatography (GPC) is preferably close to 1.0, that is, the molecular weight distribution is preferably narrow. As specific Mw/Mn values, 1.0 to 1.7 is preferable, 1.3 to 1.65 is more preferable, and 1.4 to 1.6 is most preferable.

Typically, the hydroxyl group in the 2, 3, and 6 positions in the cellulose acylate is not uniformly distributed 1/3 each of the overall substituting and there is a tendency for the substituting of the hydroxyl group in the 6 position to be small. The substituting of the hydroxyl group in the 6 position of the cellulose acylate is preferably larger compared to the 2 and 3 positions in the present invention.

With regard to the overall substituting, the hydroxyl group in the 6 position is preferably substituted by an acyl group 32% or more, more preferably 33% or more, and particularly preferably 34% or more. The substituting by the acyl group in the 6 position in the cellulose acylate is further preferably 0.88 or more. The hydroxyl group in the 6 position may be substituted by a propionyl group, a butyroyl group, a valeroyl group, a benzoyl group, an acryloyl group or the like which are acyl groups with 3 or more carbon atoms other than the acetyl group. The measuring of the substituting in each position is able to be determined using the NMR.

In the present invention, as the cellulose acylate, the cellulose acylate which is obtained using the methods disclosed in the example and the synthesis example 1 in paragraphs [0043] and [0044], the synthesis example 2 in paragraphs [0048] and [0049], and the synthesis example 3 in paragraphs [0051] and [0052] in JP1999-5851A (JP-H11-5851A) can be used.

In the optical film of the present invention, an (meth)acrylic-based resin film which can be used as the transparent base material (transparent support) will be described.

The (meth)acrylic-based resin film contains a (meth)acrylic-based resin. The (meth)acrylic-based resin film can be formed into, for example, a mold by press molding a molding material which contains a resin compound which contains the (meth)acrylic-based resin as a main component.

As the (meth)acrylic-based resin, Tg (glass transition temperature) is preferably 115° C. or more, is more preferably 120° C. or more, is even more preferably 125° C. or more, and is particularly preferably 130° C. or more. The (meth)acrylic-based resin film can obtain superior durability by including the (meth)acrylic-based resin where the Tg (glass transition temperature) is 115° C. or more as a main component. The upper limited value of the Tg of the (meth)acrylic-based resin is not particularly limited, but is preferably 170° C. or less from the point of view of formability and the like.

As the (meth)acrylic-based resin, an appropriate arbitrary (meth)acrylic-based resin can be adopted. Examples thereof include a poly(meth)acrylate ester such as a polymethyl methacrylate, a (meth)acrylate-methyl methacrylate copolymer, a methyl(meth)acrylate-(meth)acrylate ester copolymer, a methyl methacrylate-acrylate ester-methyl methacrylate copolymer, a methyl(meth)acrylate-styrene copolymer (such as a MS resin), a polymer which has an alicyclic hydrocarbon group (for example, a methyl methacrylate-cyclohexyl methacrylate copolymer, a methyl methacrylate-norbornyl(meth)acrylate copolymer, and the like). Preferable examples include a C1-6 alkyl poly(meth)acrylate such as a poly methyl(meth)acrylate. More preferable examples include a methyl methacrylate-based resin where the methyl methacrylate is the main component (50 to 100 mass % and preferably 70 to 100 mass %).

Specific examples of the (meth)acrylic-based resin include Acrypet VH and Acrypet VRL20A which are manufactured by Mitsubishi Rayon KK or a high Tg (meth)acrylic-based resin which can be obtained through cross linking in a molecule or a cyclic reaction in a molecule.

In the present invention, as the (meth)acrylic-based resin, a (meth)acrylic-based resin which has a glutaric acid anhydride structure, a (meth)acrylic-based resin which has a lactone ring structure, and a (meth)acrylic-based resin which has a glutarimide structure are preferable from the point of view of having high heat resistance, high transparency, and high mechanical strength.

Examples of the (meth)acrylic-based resin which has a glutaric acid anhydride structure include (meth)acrylic-based resins which have a glutaric acid anhydride structure described in JP2006-283013A, JP2006-335902A, JP2006-274118A, and the like.

Examples of the (meth)acrylic-based resin which has a lactone ring structure include (meth)acrylic-based resins which have a lactone ring structure described in JP2000-230016A, JP2001-151814A, JP2002-120326A, JP2002-254544A, JP2005-146084A, and the like.

Examples of the (meth)acrylic-based resin which has a glutarimide structure include (meth)acrylic-based resins which have a glutarimide structure described in JP2006-309033A, JP2006-317560A, JP2006-328329A, JP2006-328334A, JP2006-337491A, JP2006-337492A, JP2006-337493A, JP2006-337569A, JP2007-009182A, and the like.

The content of the (meth)acrylic-based resin in the (meth)acrylic-based resin film is preferably 50 to 100 mass %, is more preferably 50 to 99 mass %, is even more preferably 60 to 98 mass %, and is particularly preferably 70 to 97 mass %. In a case where the content of the (meth)acrylic-based resin in the (meth)acrylic-based resin film is less than 50 mass %, there is a concern that the high heat resistance and the high transparency which are originally derived from the (meth)acrylic-based resin are not sufficiently reflected.

The content of the (meth)acrylic-based resin in the molding material which is used when molding the (meth)acrylic-based resin film is preferably 50 to 100 mass %, is more preferably 50 to 99 mass %, is even more preferably 60 to 98 mass %, and is particularly preferably 70 to 97 mass %. In a case where the content of the (meth)acrylic-based resin in the molding material which is used when molding the (meth)acrylic-based resin film is less than 50 mass %, there is a concern that the high heat resistance and the high transparency which are originally derived from the (meth)acrylic-based resin are not sufficiently reflected.

The (meth)acrylic resin film may contain other thermoplastic resins other than the (meth)acrylic-based resin. Examples of the other thermoplastic resins include an olefin-based polymer such as polyethylene, polypropylene, ethylene-propylene copolymer, and poly(4-methyl-1-pentene); a halogenated vinyl-based polymer such as vinyl chloride, vinylidene chloride, and chlorinated vinyl resin; an acrylic-based polymer such as polymethyl methacrylate; a styrenic-based polymer such as polystyrene, styrene-methyl methacrylate copolymer, styrene-acrylonitrile copolymer, and acrylonitrile-butadiene-styrene block copolymer; a polyester such as polyethylene terephthalate, polybutylene terephthalate, and polyethylene naphthalate; a polyamide such as nylon 6, nylon 66, and nylon 610; polyacetal; polycarbonate; polyphenylene oxide; polyphenylene sulfide; polyether ether ketone; polysulfone; polyether sulfone; polyoxybenzylene; polyamide imide; a rubber polymer such as an ABS resin or a ASA resin combined with a polybutadiene-based rubber or an acrylic-based rubber, and the like.

The content of the other thermoplastic resin in the (meth)acrylic-based resin film is preferably 0 to 50 mass %, is more preferably 0 to 40 mass %, is even more preferably 0 to 30 mass %, and is particularly preferably 0 to 20 mass %.

The (meth)acrylic-based resin film may contain additives. Examples of the additives include an antioxidant which is hindered phenol-based, phosphorus-based, sulfur-based, and the like; a stabilizer such as a light stabilizer, a weathering stabilizer, or a heat stabilizer; a reinforce such as glass fiber or carbon fiber; an ultraviolet absorber such as phenyl salicylate, (2,2′-hydroxy-5-methyl phenyl)benzotriazole, or 2-hydroxy benzophenone; a near-infrared absorbing agent; a flame retardant such as tris(dibromopropyl)phosphate, triallyl phosphate, or antimony oxide; an antistatic agent such as an anionic-based, cationic-based, or nonionic-based surfactant; a colorant such as an inorganic pigment, an organic pigment, or a dye; an organic filler or an inorganic filler; a resin modifier; an organic filling agent or an inorganic filling agent; a plasticizer; a lubricant; an antistatic agent; a flame retardant; a phase difference reduction agent, and the like.

The content of the additives in the (meth)acrylic-based resin film is preferably 0 to 5 mass %, is more preferably 0 to 2 mass %, and is even more preferably 0 to 0.5 mass %.

The manufacturing method of the (meth)acrylic-based resin film is not particularly limited, but for example, the (meth)acrylic-based resin, the other polymers, the additives, and the like are sufficiently mixed using an arbitrary appropriate mixing method and a film can be formed from this as a thermoplastic resin composition in advance. Alternatively, the (meth) acrylic-based resin, the other polymers, the additives, and the like may be mixed after each being individually made in solutions and a film may be formed after a uniform mixture solution is made.

In the manufacturing of the thermoplastic resin composition, for example, after the film materials have been preblended using an arbitrary appropriate mixer such as an omni mixer, the obtained mixture is extruded and kneaded. In this case, the mixer which is used in the extruding and kneading is not particularly limited, but for example, an arbitrary appropriate mixer such as an extruder such as a single-screw extruder or a twin-screw extruder or a pressure kneader can be used.

Examples of the method of film forming include arbitrary appropriate film forming methods such as a solution casting method, a melt extrusion method, a calendar method, and a compression molding method. Out of these film forming methods, a solution casting method and a melt extrusion method are preferable.

Examples of the solvent which can be used in the solution casting method include aromatic hydrocarbons such as benzene, toluene, and xylene; aliphatic hydrocarbons such as cyclohexane and decalin; esters such as ethyl acetate and butyl acetate; ketones such as acetone, methyl ethyl ketone, and methyl isobutyl ketone; alcohols such as methanol, ethanol, isopropanol, butanol, isobutanol, methyl cellosolve, ethyl cellosolve, and butyl cellosolve; ethers such as tetrahydrofuran and dioxane; halogenated hydrocarbons such as dichloromethane, chloroform, and carbon tetrachloride; dimethylformamide; dimethyl sulfoxide, and the like. The solvents can be used as one type or two or more types in combination.

Examples of the device for performing the solution casting method include a drum-type casting machine, a band-type casting machine, and a spin coater.

Examples of the melt extrusion method include a T dye method, an inflation method, and the like. The forming temperature is preferable 150 to 350° C. and is more preferable 200 to 300° C.

In a case of film forming using the T dye method, a film in a roll shape can be obtained by a T dye being attached to a tip edge section of a known single-screw extruder or twin-screw extruder and a film which is extruded in a film shape being wound. At this time, uniaxial stretching is possible by appropriately adjusting the temperature of the winding roller and adding stretching in an extruding direction. In addition, simultaneous biaxial stretching, sequential biaxial stretching, and the like can be also performed by stretching the film in a direction which is orthogonal to the extrusion direction.

The (meth)acrylic-based resin film may be either an unstretched film or a stretched film. In the case of the stretched film, there may be either a uniaxially stretched film or a biaxially stretched film. In the case of a biaxially stretched film, there may be either a simultaneous biaxially stretched film or a sequential biaxially stretched film. In the case of the biaxial stretching, the mechanical strength is improved and the film performance is improved. The (meth)acrylic-based resin film can suppress an increase in the phase difference even with stretching and can be maintained to have optical isotropy due to another thermoplastic resin being mixed in.

The stretching temperature is preferably in the vicinity of the glass transition temperature of the thermoplastic resin composition which is the film material, and specifically, is preferably (glass transition temperature−30° C.) to (glass transition temperature+100° C.) and is more preferably in the range of (glass transition temperature−20° C.) to (glass transition temperature+80° C.). When the stretching temperature is less than (glass transition temperature−30° C.), there is a concern that a sufficient stretching ratio is not obtained. Conversely, when the stretching temperature exceeds (glass transition temperature+100° C.), there is a concern that flow of the resin composition occurs and stable stretching cannot be performed.

The stretching ratio which is defined as an area ratio is preferably 1.1 to 25 times and is more preferably 1.3 to 10 times. When the stretching ratio is less than 1.1 times, there is a concern that there will be no improvement in toughness which accompanies stretching. When the stretching ratio exceeds 25 times, there is a concern that there will be no recognized effect from increasing the stretching ratio.

The stretching speed in one direction is preferably 10 to 20,000%/min and is more preferably 100 to 10,000%/min When the stretching speed is less than 10%/min, there is a concern that it will take time to obtain a sufficient stretching ratio and that manufacturing costs will be high. When the stretching speed exceeds 20,000%/min, there is a concern that breakage of the stretched film and the like will occur.

A heating process (annealing) and the like can be performed on the (meth)acrylic-based resin film after the stretching process in order to stabilize the optical isotropy and mechanical properties. Arbitrary appropriate conditions can be adopted as the conditions of the heating process.

The thickness of the (meth)acrylic-based resin film is preferably 5 to 200 μm and is more preferably 10 to 100 μm. When the thickness is 5 μm or more, it is preferable as the strength is not lowered and crimping is not large in durability tests on a polarization plate. If the thickness is 200 μm or less, it is preferable as the transparency is not reduced and moisture penetration is not small, and in the case where a water-based adhesive agent is used, the speed of the drying of the water of the solvent thereof is not slow.

The wetting tension of the surface of the (meth)acrylic-based resin film is preferably 40 mN/m or more, is more preferably 50 mN/m or more, and is even more preferably 55 mN/m or more. When the wetting tension of the surface is at least 40 mN/m or more, for example, the adhesion strength of the (meth)acrylic-based resin film and a polarization film is further improved when forming a polarization plate which uses the optical film of the present invention. An arbitrary appropriate surface process can be carried out in order to adjust the wetting surface tension. Examples of the surface process include a corona discharge process, a plasma process, spraying ozone, ultraviolet irradiation, flame process, and a chemical process. Out of these, a corona discharge process or a plasma process are preferable.

Characteristics of Antistatic Hard Coat Layer

The antistatic hard coat layer of the present invention preferably has a refraction index of 1.48 to 1.65, more preferably 1.48 to 1.60, and most preferably 1.48 to 1.55. It is preferable as interference roughness in the base material are suppressed and reflected color is neutralized when a low refractive index layer is further laminated by the refractive index being in the range above.

The film thickness of the antistatic hard coat layer is preferably 1 μm or more, is more preferably 3 μm to 20 μm, is more preferably 5 μm to 15 μm, and is most preferably 6 μm to 15 μm. Physical strength and antistatic properties can be compatible when the thickness is in the range above.

In addition, the strength of the antistatic hard coat layer is preferably H or more, is more preferably 2H or more, and is most preferably 3H or more in pencil hardness tests. Furthermore, a lower amount of wear of a test specimen before and after the test is preferable in a taber test according to JIS K5400: 1990.

The transparency of the antistatic hard coat layer is preferably 80% or more, is more preferably 85% or more, and is most preferably 90% or more.

Characteristics of Optical Film

The common logarithmic value (Log SR) of the surface resistivity SR (Ω/sq) of the optical film of the present invention is preferably low, is preferably 12 or less, is more preferably 5 to 11 or less, and is even more preferably 6 to 10 in an environment of 25° C. and 60% RH from the point of view of the antistatic properties. Imparting of superior dust resistance is possible by the surface resistivity being in the range above.

Optical Film Preparation Method

The optical film of the present invention can be formed using the following method but is not limited to this method.

First, the antistatic hard coat layer forming composition is adjusted. Next, the composition is coated on the transparent support using a dip coating method, an air knife coating, a curtain coating method, a roller coating method, a wire bar coating method, a gravure coating method, a die coating method, and the like and heating and drying is carried out. A micro gravure coating method, a wire bar coating method, or a die coating method (refer to U.S. Pat. No. 2,681,294A and JP2006-122889A) is more preferable and a die coating method is particularly preferable.

The layer, which is formed from the antistatic hard coat layer forming composition by drying and light irradiation after the coating of the composition on the transparent support, is cured, and due to this, the antistatic hard coat layer is formed. Other layers (a layer which configures a film which is described below, for example, a hard coat layer, an antiglare layer, or the like) are coated in advance on the transparent support as required and the antistatic hard coat layer can be formed on this. In the manner, the optical film of the present invention can be obtained. As the optical film manufacturing method of the present invention, a method which has a process where the antistatic hard coat layer forming composition is coated on a transparent base material (preferably, an cellulose acylate film) and an antistatic hard coat layer is formed by curing is preferable.

High Refractive Index Layer and Middle Refractive Index Layer

The optical film of the present invention may further have a high refractive index layer and a middle refractive index layer.

The refractive index of the high refractive index layer is preferable 1.65 to 2.20 and is more preferably 1.70 to 1.80. The refractive index of the middle refractive index layer is adjusted to be a value between the refractive index of the low refractive index layer and the refractive index of the high refractive index layer. The refractive index of the middle refractive index layer is preferable 1.55 to 1.65 and is more preferably 1.58 to 1.63.

The method for forming the high refractive index layer and the middle refractive index layer can use a transparent thin film which is an inorganic oxide compound using a chemical vapor deposition (CVD) method and physical vapor deposition (PVD) method, and in particular, a vacuum deposition method or a sputtering method which is a type of physical vapor deposition method, and a method using an all wet coating is preferable.

The middle refractive index layer and the high refractive index layer are not particularly limited as long as the layers are layers in the above ranges of refractive indices, and a known compound can be used as a constituent component, and are specifically shown in paragraphs [0074] to [0094] in JP2008-262187A.

Low Refractive Index Layer

The optical film of the present invention preferably has a low refractive index layer which has a refractive index which is lower than the antistatic hard coat layer directly on the antistatic hard coat layer or via other layers. In this case, the optical film of the present invention can function as an antireflection film.

In this case, the low refractive index layer preferably has a refractive index of 1.30 to 1.51, more preferably 1.30 to 1.46, and even more preferably 1.32 to 1.38. It is preferable as reflectivity is suppressed and film strength can be maintained when the refractive index is in the range above. The method for forming the low refractive index layer can use a transparent thin film which is an inorganic oxide compound using a chemical vapor deposition (CVD) method and physical vapor deposition (PVD) method, and in particular, a vacuum deposition method or a sputtering method which is a type of physical vapor deposition method, and a method using an all wet coating is preferably used in the low refractive index layer composition.

The low refractive index layer are not particularly limited as long as the layer is a layer in the above ranges of refractive indices, and a known compound can be used as a constituent component, and specifically, a compound which has a fluorine-containing curable resin and inorganic fine particles which is described in JP2007-298974A or a low refractive index coating containing hollow silica fine particles which is described in JP2002-317152A, JP2003-202406A, and JP2003-292831A can be appropriately used.

The refractive indexes of each of the layers in the optical film of the present invention can be determined using fitting of a reflectance spectra which is obtained using a reflectance spectroscopy film pressure gauge FE3000 (manufactured by Otsuka Electronics Co. Ltd) and a reflectance spectra which is calculated from an optical model with multiple layers of thin films which uses a Fresnel coefficient.

In the present invention, a multifunctional monomer which has a polymerizable unsaturated group is preferably used as a binder which is used in the low refractive index layer.

The multifunctional monomer which can be used in the present invention will be described. Examples of the multifunctional monomer include a compound which has a polymerizable functional group such as a (meth)acryloyl group, a vinyl group, a styryl group, and an allyl group. Out of these, a (meth)acryloyl group is preferable. In particular, a compound which contains two or more (meth)acryloyl groups in one molecule can be preferably used.

Specific examples of the multifunctional monomer (a compound which has a polymerizable functional group) can include alkylene glycol(meth)acrylate diesters such as neopentyl glycol acrylate, 1,6-hexanediol(meth)acrylate, propylene glycol di(meth)acrylate; polyoxyalkylene glycol(meth)acrylate diesters such as triethylene glycol di(meth)acrylate, dipropylene glycol di(meth)acrylate, polyethylene glycol di(meth)acrylate, polypropylene glycol di(meth)acrylate

polyhydric alcohol(meth)acrylate diesters such as pentaerythritol di(meth)acrylate; and

(meth)acrylate diesters with an ethylene oxide or a propylene oxide adduct such as 2,2-bis{4-(acryloxy-diethoxy) phenyl}propane, 2-2-bis{4-(acryloxy-polypropoxy)phenyl}propane; and the like.

Furthermore, epoxy(meth)acrylates, urethane(meth)acrylates, and polyester(meth)acrylates can be preferably used as the photo-polymerizable multifunctional monomer.

Out of these, esters of (meth)acrylate and polyhydric alcohol are preferable. More preferably, a multifunctional monomer which has three or more (meth)acryloyl groups in one molecule is preferable. Examples thereof include pentaerythritol tetra(meth)acrylate, pentaerythritol tri(meth)acrylate, trimethylolpropane tri(meth)acrylate, trimethylolpropane tri-modified EO(meth)acrylate, trimethylolpropane tri modified PO(meth)acrylate, tri-phosphate-modified EO(meth)acrylate, trimethylol ethane tri(meth)acrylate, ditrimethylolpropane tetra(meth)acrylate, dipentaerythritol tetra(meth)acrylate, dipentaerythritol penta(meth)acrylate, dipenta pentaerythritol hexa(meth)acrylate, pentaerythritol hexa(meth)acrylate, 1,2,3-cyclohexane tetra methacrylate, polyurethane polyacrylate, polyester polyacrylate, caprolactone-modified tris(acryloxyethyl)isocyanurate, and the like.

Specific example of the multifunctional acrylate-based compounds which has a (meth)acryloyl group include esters of (meth)acrylic acid and the polyol such as KAYARAD DPHA, DPHA-2C, PET-30, TMPTA, TPA-320, TPA-330, RP-1040, T-1420, D-310, DPCA-20, DPCA-30, DPCA-60, and GPO-303 manufactured by Nippon Kayaku Co., Ltd., NK Ester A-TMMT, A-TMPT, A-DPH manufactured by Shin-Nakamura Chemical Co., Ltd, V#3PA, V#400, V#36095D, V#1000, and V#1080 manufactured by Osaka Organic Chemical Industry Ltd. In addition, a urethane acrylate compound with three or more functions such as UV-1400B, UV-1700B, UV-6300B, UV-7550B, UV-7600B, UV-7605B, UV-7610B, UV-7620EA, UV-7630B, UV-7640B, UV-6630B, UV-7000B, UV-7510B, UV-7461TE, UV-3000B, UV-3200B, UV-3210EA, UV-3310EA, UV-3310B, UV-3500BA, UV-3520TL, UV-3700B, UV-6100B, UV-6640B, UV-2000B, UV-2010B, UV-2250EA, and UV-2750B (manufactured by Nippon Synthetic Chemical Industry Co., Ltd.), UL-503LN (manufactured by Kyoeisha Chemical Co., Ltd.), Unidec 17-806, Unidec 17-813, Unidec V-4030, and Unidec V-4000BA (manufactured by DIC Corporation), EB-1290K, EB-220, EB-5129, EB-1830, and EB-4858 (manufactured by Daicel UCB), HICORP AU-2010 and AU-2020 (manufactured by Tokushiki Co., Ltd.), a urethane acrylate compound with 3 or more functions such as Aronix M-1960 (manufactured by Toagosei Co., Ltd), Art Range UN-3320HA, UN-3320HC, UN-3320HS, UN-904, and HDP-4T, and the like, and a polyester compound with 3 or more functions such as Aronix M-8100, Aronix M-8030 and M-9050 (manufactured by Toagosei Co., Ltd), KRM-8307 (manufactured by Daicel Cytec Co., Ltd.), and the like can be appropriately used. In particular, DPHA and PET-30 are preferably used.

Furthermore, examples thereof include a resin having three or more (meth)acryloyl groups, for example, a relatively low molecular weight polyester resin, a polyether resin, an acrylic resin, an epoxy resin, a urethane resin, an alkyd resin, a spiroacetal resin, a polybutadiene resin, a polythiol-polylene resin, and an oligomers or prepolymer such as a multi-functional compound such as polyhydric alcohol and the like.

As the monomer binder, for example, a dendrimer which is described in JP2005-76005A or JP2005-36105A, for example, a norbornene ring-containing monomer such as described in JP2005-60425A can be used.

Two or more types of multifunctional monomers can be used in combination. The polymerization of the multifunctional monomer which has a polymerizable unsaturated group is possible by performing irradiation of ionizing radiation or heating in the presence of a photo-radical initiator or a heat radical initiator.

The added amount of the multifunctional monomer in the total solid content of the low refraction index layer is preferably 10 to 90 mass %, is more preferably 20 to 70 mass %, and is most preferably 30 to 60 mass % in order to strengthen the coating film.

The inorganic fine particles which can be used in the low refractive index layer of the present invention will be described. In the present invention, the use of the inorganic fine particles in the low refractive index layer is preferable from the point of view of lowering the refractive index and improving scratch resistance.

Examples of the inorganic fine particles include fine particles of magnesium fluoride or silica since the refractive index is low. In particular, silica fine particles are preferable from the point of the refractive index, dispersion stability, and cost. The size of the inorganic fine particles (primary particles) is preferable 10 to 150 nm, is more preferably 20 to 120 nm, and is most preferably 40 to 90 nm

To achieve the lowering of the refractive index, the use of fine particles which are porous or a hollow structure is preferable. In particular, the use of silica particles with a hollow structure are preferable. The porosity of these particles is preferably 10 to 80%, is more preferably 20 to 60%, and is most preferably 30 to 60%. The porosity of the hollow fine particles being in the range described above is preferable from the point of view of the lowering of the refractive index and maintaining durability of the particles.

In a case of porous or hollow particles are silica, the refractive index of the fine particles is preferably 1.10 to 1.40, is more preferably 1.15 to 1.35, and is most preferably 1.15 to 1.30. Here, the refractive index represents the refractive index of the entire particle and does not represent the refractive index of only the outer shell of the silica which forms the silica particles.

The added amount of the inorganic fine particles is preferably 10 mass % to 70 mass % with regard to the total solid content of the low refractive index layer. 20 mass % to 60 mass % is more preferable and 30 mass % to 50 mass % is most preferable.

The surfaces of the inorganic fine particles are preferably processed using organosilane hydrolyzate and/or a partial condensate thereof in order to improve the dispersion in the binder for forming of the low refractive index layer and scratch resistance, and during the process, either or both of an acid catalyst and a metal chelate compound are more preferably used. As the organosilane compound which can be used in the surface processing, a known compound such as described in JP2006-117924A can be used.

A polymerization initiator is preferably used in the low refractive index layer of the present invention in order to cure the binder component which has a polymerizable unsaturated group. The same as is used in the antistatic hard coat layer described above as the polymerization initiator can be appropriately used.

In the present invention, the use of a fluorine-based or a silicon-based antifouling agent is preferable to improve surface sliding, scratch resistance, and impart antifouling. The antifouling agent preferably has a reactive group such as a vinyl group or a (meth)acryloyl group. As the molecular weight of the fluorine-based or the silicon-based antifouling agent, 1,000 to 50,000 can be preferably used from the point of view of antifouling and solubility in the coating solution. 2,000 to 20,000 is more preferable.

Specific examples of the silicon-based antifouling agent include Cylaplane FM-7711, FM-7721, FM-7725, FM0711, FM0721, FM-0725, TM-0701, and TM-0701T (manufactured by JNC Corporation), X22-164A, X22-164B, X22-164C, X22-164E, X22-174DX, and X22-2426 (manufactured by Shin-Etsu Chemical Co., Ltd.), UV3500, UV3510, and UV3530 (manufactured BYK Japan), BY16-004 and SF8428 (manufactured by Dow Corning Toray Silicone Co., Ltd.), TEGO Rad2300, TEGO Rad2500, TEGO Rad2600, TEGO Rad2650, and TEGO Rad2700 (manufactured by Evonik Degussa), and RMS-033, RMS-044, RMS-083, UMS-182, UMS-992, and UCS-052 (manufactured by Gelest, Inc.), VPS-1001 (manufactured by Wako Pure Chemical Industries, Ltd), and the like. In particular, Cylaplane FM-7711, FM-7721, FM-7725, FM0711, FM0721, FM-0725, VPS-1001, TEGO Rad2300, TEGO Rad2500, TEGO Rad2600, RMS-033, X22-164B, X22-164C, and X22-164E are preferable.

As specific examples of the fluorine-based antifouling agent, the compounds described in JP2010-152311A can be appropriately used.

The content of the silicon-based or fluorine-based antifouling agent in the low refractive index layer composition in regard to the total solid content of the composition is preferably 0.1 to 15 mass %, is more preferably 1 to 10 mass %, and is even more preferably 1 to 5 mass % from the point of view of antifouling, scratch resistance, and the like.

The silicon-based or fluorine-based antifouling agent may use two or more types, and in this case, the total content is preferably in the range above.

The low refractive index layer forming composition of the present invention has an organic solvent. By containing the organic solvent, the low refractive index layer which is a thin film can be uniformly formed. Examples of the organic solvent include one type singly or a combination of two or more types of ketones such as acetone, methyl isobutyl ketone, methyl ethyl ketone, cyclohexanone, and methyl amyl ketone, esters such as ethyl acetate, butyl acetate, and propylene glycol monomethyl ether acetate, alcohols such as propylene glycol monomethyl ether, methanol, ethanol, sec-butanol, t-butanol, 2-propanol, and isopropanol, aromatics such as benzene, toluene, chlorobenzene, aliphatics such as hexane and cyclohexane, and the like. Out of these, ketones such as acetone, methyl isobutyl ketone, methyl ethyl ketone, cyclohexanone, and methyl amyl ketone, esters such as ethyl acetate, butyl acetate, propylene glycol monomethyl ether acetate, and alcohols such as propylene glycol monomethyl ether, methanol, ethanol, sec-butanol, t-butanol, 2-propanol, and isopropanol are preferable, and one type singly or a combination of two or more types of methyl ethyl ketone, methyl isobutyl ketone, methyl amyl ketone, t-butanol, and propylene glycol monomethyl ether acetate are more preferable.

Polarization Plate Protection Film

In a case where the optical film is used as a surface protection film of a polarization film (referred to below as “polarization plate protection film” or “protection film”), it is possible to improve the adhesion to the polarization film where polyvinyl alcohol is the main component by performing a so-called saponification process which is the hydrophilating of a surface of the transparent support on the opposite side to the side which has the antistatic hard coat layer, that is the surface of the side where the polarization film is attached.

Out of the two protection films which protect both surfaces of the polarization film, the film other than the optical film is preferably an optical compensation film which has an optical compensation layer including an optically anisotropic layer. The optical compensation film (phase difference film) can improve the viewing angle characteristics of a liquid crystal display screen.

As the optical compensation film, a known film can be used, but the optical compensation film described in JP2001-100042A is preferable from the point of widening the viewing angle.

The saponification process described above will be described. The saponification process is a process where the optical film is immersed in an alkali aqueous solution which has been heated for a certain period of time and acid washing is performed to neutralize after washing with water. Since, as long as the surface of the transparent support on the side where the polarization film is attached is immersed in water, any conditions of the process are suitable, the concentration of the processing agent, the temperature of the processing agent solution, and the process time can be appropriately determined, but the conditions of the process are determined so that processing is possible within 3 minutes which is necessary to secure normal productivity. As the typical conditions, the alkali concentration is 3 mass % to 25 mass %, the process temperature is 30° C. to 70° C., and the process time is 15 seconds to 5 minutes. Sodium hydroxide and potassium hydroxide are appropriate as types of alkali which are used in the alkali process, sulfuric acid is appropriate as the acid used in the acid washing, and ion-exchange water or pure water are appropriate as the water for using in water washing.

The antistatic hard coat layer of the optical film of the present invention excellently maintains the antistatic properties even if exposed to the alkali aqueous solution due to the saponification process.

In a case where the optical film of the present invention is used as the surface protection film (polarization plate protection film) of the polarization film, the cellulose acylate film as the transparent base material is preferably cellulose triacetate film.

Polarization Plate

Next, the polarization plate of the present invention will be described.

The polarization plate of the present invention is a polarization plate which has the polarization film and two protective films which protect both surfaces of the polarization film and at least one of the protective films is the optical film of the present invention or an antireflection film (the optical film of the present invention which has the low refractive index layer).

An iodine-based polarizing film, a pigment-based polarization film which uses a dichroic dye, or a polyene-based polarizing film are in the polarization film. The iodine-based polarizing film and the pigment-based polarizing film can be typically manufactured by using a polyvinyl alcohol-based film.

The transparent base material (cellulose acylate film) of the optical film and the antireflection film is attached to the polarizing film using an adhesion agent layer formed from polyester urethane or polyvinyl alcohol as required and may an adhesive agent layer in the surface on the opposite side to the side where the polarization film is attached in the protective film on the other side of the polarization film.

By the optical film of the present invention being used as the polarization plate protection film, a polarization plate with superior physical strength, antistatic properties, and durability can be manufactured.

In addition, the polarization plate of the present invention can have an optical compensation function. In this case, it is preferable that only one surface side of either the front surface or the rear surface of the polarization plate is formed using the optical film described above and the other surface side of the polarization plate is formed using the optical compensation film.

By manufacturing the polarization plate using the optical film of the present invention as one of the polarization plate protection films and using the optical compensation film with optical isotropy as the other polarization plate protection film, further improvement in the contrast in a bright room and the viewing angle up, down, right and left is possible in an liquid crystal display device.

Image Display Device

The image display device of the present invention has the polarization plate or the optical film of the present invention as an outermost surface of the display.

The optical film and the polarization plate of the present invention can be appropriately used in an image display device such as a liquid crystal display device (LCD), a plasma display panel (PDP), an electroluminescent display (ELD), or a cathode ray tube display device (CRT).

In particular, effective use in an image display device such as a liquid crystal display device is possible and use in the outermost layer on the side of the back light of a liquid crystal cell is particularly preferable in the transparent-type and semi-transparent-type of liquid crystal display devices.

Typically, the liquid crystal display device has a liquid crystal cell and two polarization plates which are arranged on both sides thereof and the liquid crystal cell supports liquid crystals between two electrode substrates. Furthermore, one sheet of an optical isotropic layer is arranged between the liquid crystal cell and one of the polarization plates or two sheets are arranged between the liquid crystal cell and both polarization plates.

The liquid crystal cell is preferably a TN mode, a VA mode, an OCB mode, an IPS mode, or an ECB mode.

### EXAMPLES

Below, the present invention will be described more specifically using examples, but it is not to be interpreted that the scope of the present invention is limited thereto. Here, unless otherwise specifically mentioned, “parts” and “%” refer to mass. In addition, in the present invention, weight average molecular weight is measured by the following conditions.
Apparatus: HLC-8220GPC (manufactured by Tosoh Co., Ltd.)
Column: TSKgel Super AWM-H (6.0 mm I.D.×15 cm)×2
Eluent: 5 mM TFA Na in TFEA (trifluoroethanol)
Flow rate: 0.5 mL/min
Sample concentration: 2.0 g/L
Column temperature: 40° C.
Detector: HLC-8220GPC equipped with a RI detector
Detect condition: RI; Pol (+), Res (0.5 s)
Molecular marker: Polymethylmethacrylate

### Example 1

Preparation of Optical Film

As shown below, optical film samples 1 to 43 and 54 to 66 were prepared by the antistatic hard coat layer forming composition (coating solution) being prepared and the antistatic hard coat layer (referred to below as “hard coat layer”) being formed on the transparent base material.

Synthesis of Ion-Conducting Compound (Conductive Polymer) (a) IP-15

As a compound corresponding to (A-2) in JP4600605B, IP-15 (30 mass % of ethanol solution) which was a quaternary ammonium salt-containing polymer which has an ethylene oxide chain was synthesized in the same manner as the synthesis example 2 in the patent document. The weight average molecular weight measured using GPC was approximately 200,000.

Synthesis of Ion-Conducting Compound (a) IP-16

As a compound corresponding to (A-5) in JP4678451B, IP-16 (30 mass % of ethanol solution) which was a quaternary ammonium salt-containing polymer which has an ethylene oxide chain was synthesized in the same manner as the synthesis example 5 in the patent document. The weight average molecular weight measured using GPC was approximately 150,000.

Synthesis of Ion-Conducting Compound (a) IP-17

As a compound corresponding to (A-6) in JP4678451B, IP-17 (30 mass % of ethanol solution) which is a quaternary ammonium salt-containing polymer which has an ethylene oxide chain was synthesized in the same manner as the synthesis example 6 in the patent document, except that the reaction temperature was changed to 70° C. and the reaction time was changed to 6 hours. The weight average molecular weight measured using GPC was approximately 60000.

Synthesis of Ion-Conducting Compound (a) IP-18

As a compound corresponding to (A-7) in JP4678451B, IP-18 (30 mass % of ethanol solution) which is a quaternary ammonium salt-containing polymer which has an ethylene oxide chain was synthesized in the same manner as the synthesis example 7 in the patent document, except that the reaction temperature was changed to 70° C. and the reaction time was changed to 6 hours. The weight average molecular weight measured using GPC was approximately 60000.

Preparation of Antistatic Hard Coat Layer Coating Solution

Each component which is in the composition of an antistatic hard coat layer coating solution A-1 described in Table 1 was mixed, the obtained composition was put into a mixing tank and stirred, and became the antistatic hard coat layer coating solution A-1 (nonvolatile concentration of 60 mass %) by filtering using a polypropylene filter with hole diameters of 0.4 μm.

Using the same method as the antistatic hard coat layer coating solution A-1, the antistatic hard coat layer coating solutions A-2 to A-43 and A-54 to A-62 were prepared by mixing each component as described in Table 1 to Table 3 and dissolving in a solvent to be in a composition ratio as described in Table 1 to Table 3.

Preparation of (Meth)Acrylic-based Resin Film

A pellet of [a mixture of 90 mass % of a (meth)acrylic-based resin which has a lactone ring structure represent by the general formula (1A) {copolymer monomer mass ratio=methyl methacrylate/2-(hydroxymethyl)methyl acrylate=8/2, rate of cyclization to lactone=substantially 100%, content ratio of lactone ring structure of 19.4%, weight average molecular weight of 133000, melt flow rate of 6.5 g/10 minutes (240° C., 10 kgf), Tg 131° C.} and 10 mass % of an acrylonitrile-styrene (AS) resin {Toyo AS AS20 manufactured by Toyo Styrene Co., Ltd}; Tg 127° C.] was supplied to a twin-screw extruder, was melted and extruded into a sheet form at approximately 280° C., and a (meth)acrylic-based resin sheet which has a lactone structure with a thickness of 110 μm was obtained. The unstretched sheet was stretched to 2.0 times lengthwise and 2.4 times widthwise under the conditions of a temperature of 160° C. and a (meth)acrylic-based resin film-1 (thickness: 40 μm) was obtained.

In addition, a (meth)acrylic-based resin film-2 (thickness: 20 μm) and a (meth)acrylic-based resin film-3 (thickness: 10 μm) were obtained in the same manner.

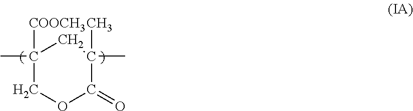

Corona Discharge Process

A corona discharge process (corona discharge electron irradiation amount: 77 W/m²/min) was carried out on one surface of the obtained (meth)acrylic-based resin film.

Forming of Easy Adhesion Layer

An easy adhesion agent composition was obtained by mixing 16.8 g of polyester-urethane (manufactured by Dai-ichi Kogyo Seiyaku Co., Ltd., product name: Superflex 210, solid content: 3.3%), 4.2 g of a cross-linking agent (oxazoline-containing polymer manufactured by Nippon Shokubai Co., Ltd, product name: Epocros WS-700, solid content: 25%), 2.0 g of 1 mass % of ammonia water, 0.42 g of colloidal silica (manufactured by Fuso Chemical, Co., Ltd, product name: Quatron PL-3, solid content: 20 mass %), and 76.6 g of pure water.

The obtained easy adhesion agent composition was coated on a bar coders (#6) on a corona discharge process surface of a (meth)acrylic resin film, where a corona discharge process has been carried out, so that the thickness after drying is 350 nm. After this, the (meth)acrylic resin film is put into a hot wind dryer (140° C.) and an easy adhesion layer (0.3 to 0.5 μm) was formed by the easy adhesion agent composition being dried for 5 minutes.

Preparation of Antistatic Hard Coat Layer

On a cellulose triacetate film (TDH6OUF, manufactured by Fuji Film Holdings Corporation, refractive index 1.48) as a transparent support with a thickness of 60 μm, the antistatic hard coat layer coating solution A-1 was coated using a gravure coater. After being dried for approximately 2 minutes at 60° C., while purging the nitrogen so that there is an atmosphere where the oxygen concentration is 1.0% volume or less, the coating layer was cured by irradiating ultraviolet rays with illumination of 400 mW/cm² and an irradiation amount of 150 mJ/cm² using a cooled metal halide lamp (manufactured by Eye Graphics Co., Ltd.) of 160 W/cm, the antistatic hard coat layer A-1 with a thickness of 10 μm was formed, and an optical film sample No. 1 was manufactured.

The antistatic hard coat layers A-2 to A-43 and A-54 to A-60 were manufactured using the antistatic hard coat layer coating solutions A-2 to A-43 and A-54 to A-60 with the same method and optical film sample Nos. 2 to 43 and No. 54 to 60 were manufactured.

An antistatic hard coat layer A-61 was formed on the opposite side surface of the (meth)acrylic resin film-1 (thickness: 40 μm), a (meth)acrylic resin film-2 (thickness: 20 μm), and a (meth)acrylic resin film-3 (thickness: 10 μm), with respect to the surface thereof whereon the easy adhesion layer was formed, using the antistatic hard coat layer coating solution A-61 with the same method and optical film sample Nos. 61 to 63 were manufactured.

An antistatic hard coat layer A-62 was formed on the opposite side surface of the (meth)acrylic resin film-1 (thickness: 40 μm), a (meth)acrylic resin film-2 (thickness: 20 μm), and a (meth)acrylic resin film-3 (thickness: 10 μm), with respect to the surface thereof whereon the easy adhesion layer was formed, using the antistatic hard coat layer coating solution A-62 with the same method and optical film sample Nos. 64 to 66 were manufactured.

Evaluation of Optical Film

Evaluations of the various characteristics of the optical film were performed using the methods below. The results are shown in Table 1 and Table 2.

(1) Surface Resistance Value Measurement

After having been left in the conditions of 20° C. and 15% RH for 2 hours, the samples were measured using a super-insulation resistance/micro-ammeter TR8601 (manufactured by Advantest Corporation) and the common logarithm of the surface resistance value (log SR) is shown. The antistatic properties are excellent when the log SR is small. In the present invention, less than 11.0 is preferable from the point of view of being able to suppress of dust being attached to the display when used as the polarization plate protection film.

(2) Pimple defects

Bright point defects were collected by checking of 50 m² of the optical film with transparent visual surface checking where fluorescent light is irradiated from a rear surface side and reflection visual surface checking where fluorescent light is irradiated from a coating surface side with the coating surface side on top. Furthermore, the number where the composition of the defect section is the same as the normal section is counted and the frequency (number) of the generation of pimple defects was set by analyses of the collected defects using a microscope, IR, and Raman spectroscopy equipment.

A: No generation with zero pimple defects

B: No problem with hardly any generation with 1 to 2 pimple defects

C: 3 to 5 pimple defects are generated but the low frequency is not a problem.

D: 6 or more pimple defects are generated but frequency is a problem.

(3) Hardness

A pencil hardness evaluation was performed according to the pencil hardness evaluation JIS K 5400: 1990. After the optical films were moisture adjusted for 2 hours at a temperature of 25° C., humidity of 60% RH, evaluation was carried out using a testing pencil which is stipulated in JIS S 6006: 2007. In the present invention, 2H or more is preferable.

TABLE 1

| | Antistatic hard coat layer forming composition | | | | | | | | | | | |
|---|---|---|---|---|---|---|---|---|---|---|---|---|
| | | Nonvolatile component | | | | | | | | | | |
| | | | | | | | | (c) Initiator | | | Volatile component | |
| | Compo- | (a) | | (b) Monomer having | | (f) PEO | | Irg. | Irg. | Irg. | (d) Solvent | |
| Sample | sition | Conductive polymer | | no hydroxyl group | | containing monomer | | 184 | 127 | 907 | | Boiling |
| No. | name | Type | Content | Type | Content | Type | Content | Content | Content | Content | Type | Point |
| No. 1 | A-1 | IP-15 | 5% | A-TMMT | 92% | — | — | 3% | — | — | 1-butanol | 117° C. |
| No. 2 | A-2 | IP-15 | 5% | A-TMMT | 92% | — | — | 3% | — | — | 1-pentanol | 138° C. |
| No. 3 | A-3 | IP-15 | 5% | A-TMMT | 92% | — | — | 3% | — | — | 3-methoxy- | 151° C. |
| | | | | | | | | | | | 1-propanol | |
| No. 4 | A-4 | IP-15 | 5% | A-TMMT | 92% | — | — | 3% | — | — | Isopropyl | 82.4° C. |
| | | | | | | | | | | | alcohol | |
| No. 5 | A-5 | IP-15 | 5% | A-TMMT | 92% | — | — | 3% | — | — | 2-butanol | 99° C. |
| No. 6 | A-6 | IP-15 | 5% | A-TMMT | 92% | — | — | 3% | — | — | Propylene | 120° C. |
| | | | | | | | | | | | glycol | |
| | | | | | | | | | | | monomethyl ether | |
| No. 7 | A-7 | IP-15 | 5% | A-TMMT | 92% | — | — | 3% | — | — | cyclohexanol | 161° C. |
| No. 8 | A-8 | IP-15 | 5% | A-TMMT | 92% | — | — | 3% | — | — | o-cresol | 191° C. |
| No. 9 | A-9 | IP-15 | 5% | A-TMMT | 92% | — | — | 3% | — | — | t-butanol | 82.4% |
| No. 10 | A-10 | IP-15 | 5% | A-TMMT | 92% | — | — | 3% | — | — | Diacetone | 166° C. |
| | | | | | | | | | | | alcohol | |
| No. 11 | A-11 | IP-15 | 5% | A-TMMT | 92% | — | — | 3% | — | — | 2-methyl-2- | 120-122° C. |
| | | | | | | | | | | | pentanol | |
| No. 12 | A-12 | IP-15 | 5% | A-TMMT | 92% | — | — | 3% | — | — | Butyl | 168° C./ |
| | | | | | | | | | | | cellosolve/ | 166° C. |
| | | | | | | | | | | | diacetone | |
| | | | | | | | | | | | alcohol | |
| No. 13 | A-13 | IP-15 | 5% | A-TMMT | 92% | — | — | 3% | — | — | 2-methyl- | 102° C. |
| | | | | | | | | | | | butanol | |
| No. 14 | A-14 | IP-15 | 5% | A-TMMT | 92% | — | — | 3% | — | — | Methanol | 64.7° C. |
| No. 15 | A-15 | IP-15 | 5% | A-TMMT | 92% | — | — | 3% | — | — | Water | 100° C. |
| No. 16 | A-16 | IP-15 | 5% | A-TMMT | 92% | — | — | 3% | — | — | 2-butanol/ | 99° C./ |
| | | | | | | | | | | | methanol | 64.7° C. |
| No. 17 | A-17 | IP-15 | 5% | A-TMMT | 92% | — | — | 3% | — | — | 2-butanol/ | 99° C./ |
| | | | | | | | | | | | methanol | 64.7° C. |
| No. 18 | A-18 | IP-15 | 5% | A-TMMT | 92% | — | — | 3% | — | — | 2-butanol/ | 99° C./ |
| | | | | | | | | | | | methanol | 64.7° C. |
| No. 19 | A-19 | IP-15 | 5% | A-TMMT | 92% | — | — | 3% | — | — | — | — |
| No. 20 | A-20 | IP-15 | 5% | A-TMMT | 92% | — | — | 3% | — | — | Diacetone | 166° C. |
| | | | | | | | | | | | alcohol | |
| No. 21 | A-21 | IP-15 | 5% | A-TMMT | 92% | — | — | 3% | — | — | Diacetone | 166° C. |
| | | | | | | | | | | | alcohol | |
| No. 22 | A-22 | IP-15 | 5% | A-TMMT | 92% | — | — | 3% | — | — | Diacetone | 166° C. |
| | | | | | | | | | | | alcohol | |
| No. 23 | A-23 | IP-15 | 5% | A-TMMT | 92% | — | — | 3% | — | — | Diacetone | 166° C. |
| | | | | | | | | | | | alcohol | |
| No. 24 | A-24 | IP-15 | 10% | A-TMMT | 87% | — | — | 3% | — | — | Diacetone | 166° C. |
| | | | | | | | | | | | alcohol | |
| No. 25 | A-25 | IP-15 | 20% | A-TMMT | 77% | — | — | 3% | — | — | Diacetone | 166° C. |
| | | | | | | | | | | | alcohol | |
| No. 26 | A-26 | IP-15 | 30% | A-TMMT | 67% | — | — | 3% | — | — | Diacetone | 166° C. |
| | | | | | | | | | | | alcohol | |
| No. 27 | A-27 | IP-9 | 5% | A-TMMT | 92% | — | — | 3% | — | — | Diacetone | 166° C. |
| | | | | | | | | | | | alcohol | |
| No. 28 | A-28 | IP-16 | 5% | A-TMMT | 92% | — | — | 3% | — | — | Diacetone | 166° C. |
| | | | | | | | | | | | alcohol | |
| No. 29 | A-29 | DQ-100 | 5% | A-TMMT | 92% | — | — | 3% | — | — | Diacetone | 166° C. |
| | | | | | | | | | | | alcohol | |
| No. 30 | A-30 | PED | 5% | A-TMMT | 92% | — | — | 3% | — | — | Diacetone | 166° C. |
| | | OT: PSS | | | | | | | | | alcohol | |
| No. 31 | A-31 | IP-15 | 5% | A-DPH | 92% | — | — | 3% | — | — | Diacetone | 166° C. |
| | | | | | | | | | | | alcohol | |
| No. 32 | A-32 | IP-15 | 5% | A-DPH/ | 34%/ | — | — | 3% | — | — | Diacetone | 166° C. |
| | | | | A-TMM- | 58% | | | | | | alcohol | |
| | | | | 3L | | | | | | | | |
| No. 33 | A-33 | IP-15 | 5% | A-DPH/ | 25%/ | — | — | 3% | — | — | Diacetone | 166° C. |
| | | | | A-TMM- | 67% | | | | | | alcohol | |
| | | | | 3L | | | | | | | | |
| No. 34 | A-34 | IP-15 | 5% | A-DPH/ | 25%/ | — | — | 3% | — | — | Ethanol | 78.4° C. |
| | | | | A-TMM- | 67% | | | | | | | |
| | | | | 3L | | | | | | | | |

| | Antistatic hard coat layer forming composition | | | | | | | | |
|---|---|---|---|---|---|---|---|---|---|
| | Volatile component | | | | | | | | |
| | (d) Solvent | | | | Nonvolatile | Evaluation | | | |
| Sample | SP | | (e) Solvent | | component | Log | Pimple | Pencil | |
| No. | Value | Content | Type | Content | concentration | SR | defects | hardness | Reference |
| No. 1 | 23.2 | 10% | MEK | 90% | 60% | 10.3 | B | 2.8H | Example |
| No. 2 | 22.4 | 10% | MEK | 90% | 60% | 10.1 | A | 2.8H | Example |
| No. 3 | 23.5 | 10% | MEK | 90% | 60% | 10.1 | A | 2.7H | Example |
| No. 4 | 23.7 | 10% | MEK | 90% | 60% | 11.0 | D | 2.8H | Comparative |
| | | | | | | | | | example |
| No. 5 | 22.7 | 10% | MEK | 90% | 60% | 9.8 | B | 2.8H | Example |
| No. 6 | 22.7 | 10% | MEK | 90% | 60% | 9.7 | B | 2.8H | Example |
| No. 7 | 34.4 | 10% | MEK | 90% | 60% | 9.6 | A | 2.7H | Example |
| No. 8 | 26.3 | 10% | MEK | 90% | 60% | 9.6 | A | 2.5H | Example |
| No. 9 | 22.3 | 10% | MEK | 90% | 60% | 9.4 | D | 2.8H | Comparative |
| | | | | | | | | | example |
| No. 10 | 23.9 | 10% | MEK | 90% | 60% | 9.2 | A | 2.7H | Example |
| No. 11 | 21.3 | 10% | MEK | 90% | 60% | 9.4 | D | 2.8H | Comparative |
| | | | | | | | | | example |
| No. 12 | 22.1/ | Total 10% | MEK | 90% | 60% | 9.6 | A | 2.7H | Example |
| | 23.9 | (mass ratio | | | | | | | |
| | | 2.5:7.5) | | | | | | | |
| No. 13 | 21.6 | 10% | MEK | 90% | 60% | 9.7 | D | 2.8H | Comparative |
| | | | | | | | | | example |
| No. 14 | 28.2 | 10% | MEK | 90% | 60% | 12.0 | D | 2.8H | Comparative |
| | | | | | | | | | example |
| No. 15 | 41.0 | 10% | MEK | 90% | 60% | Not | Not | Not | Comparative |
| | | | | | | Measureable | Measureable | Measureable | example |
| No. 16 | 22.7/ | Total 10% | MEK | 90% | 60% | 9.5 | B | 2.8H | Example |
| | 28.2 | (mass ratio | | | | | | | |
| | | 9:1) | | | | | | | |
| No. 17 | 22.7/ | Total 10% | MEK | 90% | 60% | 9.8 | C | 2.8H | Example |
| | 28.2 | (mass ratio | | | | | | | |
| | | 8:2) | | | | | | | |
| No. 18 | 22.7/ | Total 10% | MEK | 90% | 60% | 10.5 | D | 2.8H | Comparative |
| | 28.2 | (mass ratio | | | | | | | example |
| | | 7:3) | | | | | | | |
| No. 19 | — | 0% | MEK | 100% | 60% | 9.5 | D | 3.0H | Comparative |
| | | | | | | | | | example |
| No. 20 | 23.9 | 0.5% | MEK | 99.5% | 60% | 9.4 | B | 2.8H | Example |
| No. 21 | 23.9 | 25% | MEK | 75% | 60% | 9.2 | A | 2.5H | Example |
| No. 22 | 23.9 | 35% | MEK | 65% | 60% | 9.1 | A | <2.0H | Comparative |
| | | | | | | | | | example |
| No. 23 | 23.9 | 100% | — | 0% | 60% | 9.0 | B | <2.0H | Comparative |
| | | | | | | | | | example |
| No. 24 | 23.9 | 20% | MEK | 80% | 60% | 8.8 | A | 2.6H | Example |
| No. 25 | 23.9 | 20% | MEK | 80% | 60% | 8.7 | A | 2.2H | Example |
| No. 26 | 23.9 | 20% | MEK | 80% | 60% | 9.2 | C | <2.0H | Comparative |
| | | | | | | | | | example |
| No. 27 | 23.9 | 20% | MEK | 80% | 60% | 9.4 | A | 2.8H | Example |
| No. 28 | 23.9 | 20% | MEK | 80% | 60% | 9.2 | A | 2.8H | Example |
| No. 29 | 23.9 | 20% | MEK | 80% | 60% | 10.8 | A | 2.8H | Comparative |
| | | | | | | | | | example |
| No. 30 | 23.9 | 20% | MEK | 80% | 60% | 10.0 | A | 2.8H | Example |
| No. 31 | 23.9 | 20% | MEK | 80% | 60% | 9.3 | A | 3.0H | Example |
| No. 32 | 23.9 | 20% | MEK | 80% | 60% | 9.8 | A | 2.4H | Example |
| No. 33 | 23.9 | 20% | MEK | 80% | 60% | 10.4 | A | 2.1H | Example |
| No. 34 | 25.7 | 20% | MEK | 80% | 60% | 11.5 | D | 2.5H | Comparative |
| | | | | | | | | | example |

TABLE 2

| | Antistatic hard coat layer forming composition | | | | | | | | | | | |
|---|---|---|---|---|---|---|---|---|---|---|---|---|
| | | Nonvolatile component | | | | | | | | | | |
| | | | | | | | | (c) Initiator | | | Volatile component | |
| | Compo- | (a) | | (b) Monomer having | | (f) PEO | | Irg. | Irg. | Irg. | (d) Solvent | |
| Sample | sition | Conductive polymer | | no hydroxyl group | | containing monomer | | 184 | 127 | 907 | | Boiling |
| No. | name | Type | Content | Type | Content | Type | Content | Content | Content | Content | Type | Point |
| No. 35 | A-35 | IP-15 | 5% | A-TMMT | 92% | — | — | 3% | — | — | Diacetone | 166° C. |
| | | | | | | | | | | | alcohol | |
| No. 36 | A-36 | IP-15 | 5% | A-TMMT | 92% | — | — | 3% | — | — | Ethanol | 78.4° C. |
| No. 37 | A-37 | IP-15 | 5% | A-TMMT | 92% | — | — | 3% | — | — | Diacetone | 166° C. |
| | | | | | | | | | | | alcohol | |
| No. 38 | A-38 | IP-15 | 5% | A-TMMT | 92% | — | — | 3% | — | — | Ethanol | 78.4° C. |
| No. 39 | A-39 | IP-15 | 5% | A-TMMT | 82% | A400 | 10% | 3% | — | — | Diacetone | 166° C. |
| | | | | | | | | | | | alcohol | |
| No. 40 | A-40 | IP-15 | 5% | A-TMMT | 82% | DGE-4A | 10% | 3% | — | — | Diacetone | 166° C. |
| | | | | | | | | | | | alcohol | |
| No. 41 | A-41 | IP-15 | 5% | A-TMMT | 92% | — | — | 3% | — | — | Butyl | 168° C./ |
| | | | | | | | | | | | cellosolve/ | 166° C. |
| | | | | | | | | | | | diacetone | |
| | | | | | | | | | | | alcohol | |
| No. 42 | A-42 | IP-15 | 5% | A-TMMT | 92% | — | — | 3% | — | — | Butyl | 168° C./ |
| | | | | | | | | | | | cellosolve/ | 166° C. |
| | | | | | | | | | | | diacetone | |
| | | | | | | | | | | | alcohol | |
| No. 43 | A-43 | IP-15 | 5% | A-TMMT | 92% | — | — | 3% | — | — | Butyl | 168° C./ |
| | | | | | | | | | | | cellosolve/ | 166° C. |
| | | | | | | | | | | | diacetone | |
| | | | | | | | | | | | alcohol | |
| No. 54 | A-54 | IP-15 | 5% | A-TMMT | 72% | DGE-4A | 20% | 3% | — | — | Diacetone | 166° C./ |
| | | | | | | | | | | | alcohol/ | 82.4° C./ |
| | | | | | | | | | | | isopropyl | 78.4° C. |
| | | | | | | | | | | | alcohol/ | |
| | | | | | | | | | | | ethanol | |
| No. 55 | A-55 | IP-17 | 5% | A-TMMT | 72% | DGE-4A | 20% | 3% | — | — | Diacetone | 166° C./ |
| | | | | | | | | | | | alcohol/ | 82.4° C./ |
| | | | | | | | | | | | isopropyl | 78.4° C. |
| | | | | | | | | | | | alcohol/ | |
| | | | | | | | | | | | ethanol | |
| No. 56 | A-56 | IP-18 | 5% | UA-30 | 82% | PDE-200 | 10% | 3% | — | — | Diacetone | 166° C./ |
| | | | | 6H/PET30/ | (mass ratio | | | | | | alcohol/ | 99° C./ |
| | | | | A-TMMT | 1:1:1) | | | | | | 2-butanol/ | 78.4° C. |
| | | | | | | | | | | | ethanol | |
| No. 57 | A-57 | IP-18 | 5% | UA-30 | 82% | PDE-200 | 10% | 3% | — | — | Diacetone | 166° C./ |
| | | | | 6H/PET30/ | (mass ratio | | | | | | alcohol/ | 99° C./ |
| | | | | A-TMMT | 1:1:1) | | | | | | 1-butanol/ | 78.4° C. |
| | | | | | | | | | | | ethanol | |
| No. 58 | A-58 | IP-15 | 3% | A-TMMT | 74% | DGE-4A | 20% | — | 3% | — | Diacetone | 166° C./ |
| | | | | | | | | | | | alcohol/ | 82.4° C./ |
| | | | | | | | | | | | isopropyl | 78.4° C. |
| | | | | | | | | | | | alcohol/ | |
| | | | | | | | | | | | ethanol | |
| No. 59 | A-59 | IP-17 | 3% | A-TMMT | 74% | DGE-4A | 20% | — | 3% | — | Diacetone | 166° C./ |
| | | | | | | | | | | | alcohol/ | 82.4° C./ |
| | | | | | | | | | | | isopropyl | 78.4° C. |
| | | | | | | | | | | | alcohol/ | |
| | | | | | | | | | | | ethanol | |
| No. 60 | A-60 | IP-18 | 3% | PET30/ | 74% | DGE-4A | 20% | — | — | 3% | Diacetone | 166° C./ |
| | | | | A-TMMT | (mass ratio | | | | | | alcohol/ | 99° C./ |
| | | | | | 1:1:1) | | | | | | 1-butanol/ | 78.4° C. |
| | | | | | | | | | | | ethanol | |

| | Antistatic hard coat layer forming composition | | | | | | | | |
|---|---|---|---|---|---|---|---|---|---|
| | Volatile component | | | | | | | | |
| | (d) Solvent | | | | Nonvolatile | Evaluation | | | |
| Sample | SP | | (e) Solvent | | component | Log | Pimple | Pencil | |
| No. | Value | Content | Type | Content | concentration | SR | defects | hardness | Reference |
| No. 35 | 23.9 | 20% | MEK | 80% | 40% | 8.6 | B | 2.2H | Example |
| No. 36 | 25.7 | 20% | MEK | 80% | 30% | 10.2 | D | 2.0H | Comparative |
| | | | | | | | | | example |
| No. 37 | 23.9 | 20% | MEK | 80% | 30% | 8.4 | A | 2.0H | Example |
| No. 38 | 25.7 | 20% | MEK | 80% | 40% | 12.5 | D | 2.2H | Comparativ |
| | | | | | | | | | example |
| No. 39 | 23.9 | 20% | MEK | 80% | 60% | 8.6 | A | 2.3H | Example |
| No. 40 | 23.9 | 20% | MEK | 80% | 60% | 8.6 | A | 2.3H | Example |
| No. 41 | 22.1/ | 50% | MEK | 50% | 60% | 9.5 | A | <2.0H | Comparative |
| | 23.9 | (mass ratio | | | | | | | example |
| | | 1:3) | | | | | | | |
| No. 42 | 22.1/ | 25% | MEK/ | 40%/35% | 60% | 9.6 | A | 2.3H | Example |
| | 23.9 | (mass ratio | cyclo- | | | | | | |
| | | 1:3) | hexanone | | | | | | |
| No. 43 | 22.1/ | 25% | MEK/ | 30%/45% | 60% | 9.6 | A | 2.0H | Example |
| | 23.9 | (mass ratio | cyclo- | | | | | | |
| | | 1:3) | hexanone | | | | | | |
| No. 54 | 23.9/ | 20% | MEK/ | 60%/20% | 60% | 9.0 | A | 2.3H | Example |
| | 23.7/ | (mass ratio | methyl | | | | | | |
| | 25.7 | 8:1:1) | acetate | | | | | | |
| No. 55 | 23.9/ | 20% | MEK/ | 60%/20% | 60% | 9.0 | A | 2.3H | Example |
| | 23.7/ | (mass ratio | methyl | | | | | | |
| | 25.7 | 8:1:1) | acetate | | | | | | |
| No. 56 | 23.9/ | 20% | MEK/ | 60%/20% | 30% | 8.6 | A | 2.0H | Example |
| | 22.7/ | (mass ratio | methyl | | | | | | |
| | 25.7 | 4:4:2) | acetate | | | | | | |
| No. 57 | 23.9/ | 20% | MEK/ | 60%/20% | 30% | 8.6 | B | 2.0H | Example |
| | 22.7/ | (mass ratio | methyl | | | | | | |
| | 25.7 | 6:2:2) | acetate | | | | | | |
| No. 58 | 23.9/ | 20% | MEK/ | 60%/20% | 60% | 9.6 | A | 2.3H | Example |
| | 23.7/ | (mass ratio | methyl | | | | | | |
| | 25.7 | 8:1:1) | acetate | | | | | | |
| No. 59 | 23.9/ | 20% | MEK/ | 60%/20% | 60% | 9.6 | A | 2.3H | Example |
| | 23.7/ | (mass ratio | methyl | | | | | | |
| | 25.7 | 8:1:1) | acetate | | | | | | |
| No. 60 | 23.9/ | 20% | MEK/ | 60%/20% | 30% | 10.0 | B | 2.0H | Example |
| | 22.7/ | (mass ratio | methyl | | | | | | |
| | 25.7 | 6:2:2) | acetate | | | | | | |

TABLE 3

| | Antistatic hard coat layer forming composition | | | | | | | | | |
|---|---|---|---|---|---|---|---|---|---|---|
| | | Nonvolatile component | | | | | | | | |
| | | | | | | | | (c) Initiator | | |
| | Compo- | (a) | | (b) Monomer having | | (f) PEO | | Irg. | Irg. | Irg. |
| Sample | sition | Conductive polymer | | no hydroxyl group | | containing monomer | | 184 | 127 | 907 |
| No. | name | Type | Content | Type | Content | Type | Content | Content | Content | Content |
| No. 61 | A-61 | IP-17 | 5% | A-TMMT | 72% | DGE-4A | 20% | 3% | — | — |
| No. 62 | A-61 | IP-17 | 5% | A-TMMT | 72% | DGE-4A | 20% | 3% | — | — |
| No. 63 | A-61 | IP-17 | 5% | A-TMMT | 72% | DGE-4A | 20% | 3% | — | — |
| No. 64 | A-62 | IP-17 | 3% | A-TMMT | 74% | DGE-4A | 20% | — | 3% | — |
| No. 65 | A-62 | IP-17 | 3% | A-TMMT | 74% | DGE-4A | 20% | — | 3% | — |
| No. 66 | A-62 | IP-17 | 3% | A-TMMT | 74% | DGE-4A | 20% | — | 3% | — |

| | Antistatic hard coat layer forming composition | | | | | | | |
|---|---|---|---|---|---|---|---|---|
| | Volatile component | | | | | | | |
| | (d) Solvent | | | | | | Nonvolatile | |
| Sample | | Boiling | SP | | (e) Solvent | | component | |
| No. | Type | Point | Value | Content | Type | Content | concentration | Reference |
| No. 61 | Diacetone | 166° C./ | 23.9/ | 25% | MEK/ | 56%/19% | 60% | Example |
| | alcohol/ | 82.4° C./ | 23.7/ | (mass ratio | methyl | | | |
| | isopropyl | 78.4° C. | 25.7 | 8:1:1) | acetate | | | |
| | alcohol/ | | | | | | | |
| | ethanol | | | | | | | |
| No. 62 | Diacetone | 166° C./ | 23.9/ | 25% | MEK/ | 56%/19% | 60% | Example |
| | alcohol/ | 82.4° C./ | 23.7/ | (mass ratio | methyl | | | |
| | isopropyl | 78.4° C. | 25.7 | 8:1:1) | acetate | | | |
| | alcohol/ | | | | | | | |
| | ethanol | | | | | | | |
| No. 63 | Diacetone | 166° C./ | 23.9/ | 25% | MEK/ | 56%/19% | 60% | Example |
| | alcohol/ | 82.4° C./ | 23.7/ | (mass ratio | methyl | | | |
| | isopropyl | 78.4° C. | 25.7 | 8:1:1) | acetate | | | |
| | alcohol/ | | | | | | | |
| | ethanol | | | | | | | |
| No. 64 | Diacetone | 166° C./ | 23.9/ | 25% | MEK/ | 56%/19% | 60% | Example |
| | alcohol/ | 82.4° C./ | 23.7/ | (mass ratio | methyl | | | |
| | isopropyl | 78.4° C. | 25.7 | 8:1:1) | acetate | | | |
| | alcohol/ | | | | | | | |
| | ethanol | | | | | | | |
| No. 65 | Diacetone | 166° C./ | 23.9/ | 25% | MEK/ | 56%/19% | 60% | Example |
| | alcohol/ | 82.4° C./ | 23.7/ | (mass ratio | methyl | | | |
| | isopropyl | 78.4° C. | 25.7 | 8:1:1) | acetate | | | |
| | alcohol/ | | | | | | | |
| | ethanol | | | | | | | |
| No. 66 | Diacetone | 166° C./ | 23.9/ | 25% | MEK/ | 56%/19% | 60% | Example |
| | alcohol/ | 82.4° C./ | 23.7/ | (mass ratio | methyl | | | |
| | isopropyl | 78.4° C. | 25.7 | 8:1:1) | acetate | | | |
| | alcohol/ | | | | | | | |
| | ethanol | | | | | | | |

In the table 1 to table 3, the content of each component other than the solvent is shown as a ratio (mass %) of the solid content of each component with regard to the nonvolatile component of the coating solution.

In addition, the content of each solvent is shown as a mass ratio (mass %) of the content of each solvent with regard to the total mass of all of the solvents (volatile component).

In table 1, the coating solution which is coated on the transparent support was remarkably repelled in the sample 15 which uses the composition A-15 and the hard coat layer could not be formed.

The compounds which were used in each are shown below.

IP-9: ion-conducting polymer IP-9

DQ-100: “Light Ester DQ-100”, a quaternary ammonium salt-based compound (weight average molecular weight less than 20,000), contains multifunctional monomer, photopolymerization initiator containing hard coat agent (manufactured by Kyoeisha Chemical Co., Ltd.)

PEDOT: PSS: 1.0% solution of poly(3,4-ethylenedioxythiophene)-poly(styrene sulfonate) which is (adjustment example 4) in [0126] of JP2011-31501. The solvent is MEK/acetone/water (water is 0.05%)

A-TMMT: pentaerythritol tetra acrylate (manufactured by Shin-Nakamura Chemical Co., Ltd, NK Ester)

A-TMM-3L: mixture of pentaerythritol triacrylate (content of 55 mass %), pentaerythritol diacrylate, and pentaerythritol monoacrylate (manufactured by Shin-Nakamura Chemical Co., Ltd, NK Ester)

A-DPH: dipentaerythritol hexaacrylate (manufactured by Shin-Nakamura Chemical Co., Ltd)

Irg. 184: photopolymerization initiator, Irgacure 184 (manufactured by Chiba Japan)

Irg. 127: photopolymerization initiator, Irgacure 127 (manufactured by Chiba Japan)

Irg. 907: photopolymerization initiator, Irgacure 907 (manufactured by Chiba Japan)

MEK: methyl ethyl ketone (boiling point 79.5° C.)

UA-306H: pentaerythritol triacrylate hexamethylene diisocyanate urethane prepolymer (manufactured by Kyoeisha Chemical Co., Ltd.)

PET-30: mixture of pentaerythritol triacrylate and pentaerythritol tetra acrylate (manufactured by Nippon Kayaku Co., Ltd.)

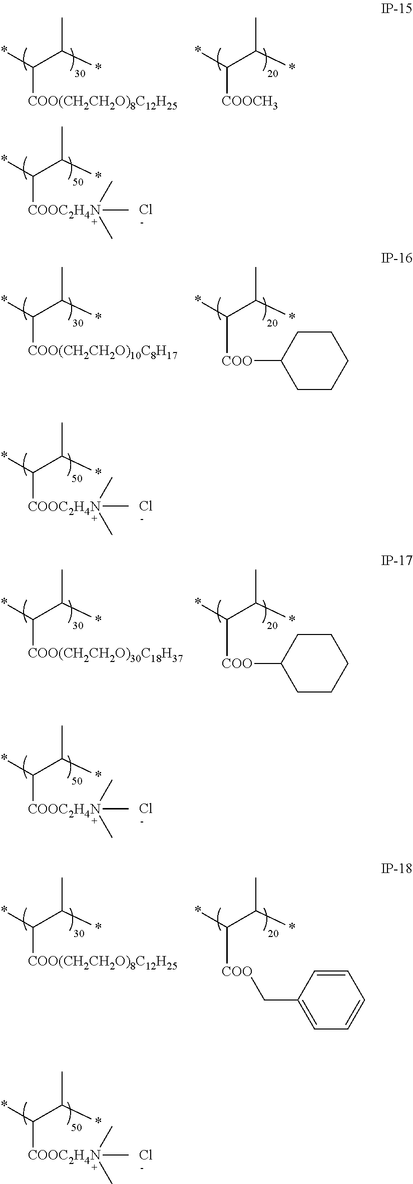

Here, the weight average molecular weights of IP-9, IP-15, IP-16, IP-17, IP-18 and PEDOT: PSS which are conductive polymers used in the examples were confirmed to be in the range of 20000 and 500000. In the conductive polymer IP-15, IP-16, IP-17, IP-18, the ratio of the repeating units is expressed in a mass ratio.

TABLE 4

| Name | Product name | Manufacturer | Structural formula |
|---|---|---|---|
| A-400 | NK Ester | Shin-Nakamura | CH₂═CHCOO—(C₂H₄O)₉—COCH═CH₂ |
| | A-400 | Chemical | |
| | | Co., Ltd | |
| DGE- | Light Ester | Kyoeisha | ((CH₂═CHCOO—(C₂H₄O))₂—CHCH₂)₄—C |
| 4A | DGE-4A | Chemical | |
| | | Co., Ltd. | |
| PDE- | Blemmer-PDE- | NOF Corporation | CH₂═C(CH₃)COO—(C₂H₄O)₄—COC(CH₃)═CH₂ |
| 200 | 200 | | |

As shown in table 1 and table 2, the optical film which has the antistatic hard coat layer which is formed using the antistatic hard coat layer forming composition of the present invention exhibits excellent antistatic properties with low surface resistance. In addition, the optical film which has the antistatic hard coat layer of the present invention suppresses the pimple defects and is superior in terms of the hardness of the film.

Using a comparison of the sample 21 which is an example and the samples 22 and 23 which are comparative examples, it is understood that the hardness of a film which can be obtained when the proportion of alcohol (component (d)) which takes up the volatile component of the antistatic hard coat layer forming composition exceeds 25 mass % is remarkably lowered.

Using a comparison of the samples 5, 16, and 17 which are examples and the sample 18 which is a comparative example, it is understood that pimple defects are generated and the surface deteriorates in a film which can be obtained when the proportion of the solvent with 4 or more carbon atoms having a hydroxyl group where the boiling point is 90° C. or more and the SP value is 22.0 or more and 35.0 or less which is the component (d2) in all of the alcohol (component (d)) which is included in the antistatic hard coat layer forming composition is 80 mass % or less.

The sample No. 61 had a log SR of 9.0, pimple defects were A, and the pencil hardness was 2.0H, and these were excellent results. In the sample Nos. 62 to 66, excellent result could be obtained even in a case where the (meth)acrylic-based resin film is used as the base material.

An optical film was manufactured in the same manner as the sample No. 1, except that a compound FP-13 (a fluorine-based surfactant dissolving in a methyl ethyl ketone to have a solid content concentration of 40 mass %) as a leveling agent was added to the antistatic hard coat layer forming composition to be 0.05 mass % with regard to the nonvolatile component of the composition, and the same result were obtained.

In addition, three types of optical films which were manufactured in the same manner as the optical film described above other than the fact that FP-14, FP-15, and FP-16 were used instead of FP-13 obtained the same results in all cases. In the compound FP-13, FP-14, FP-15, FP-16, the ratio of the repeating units is expressed in a mass ratio.

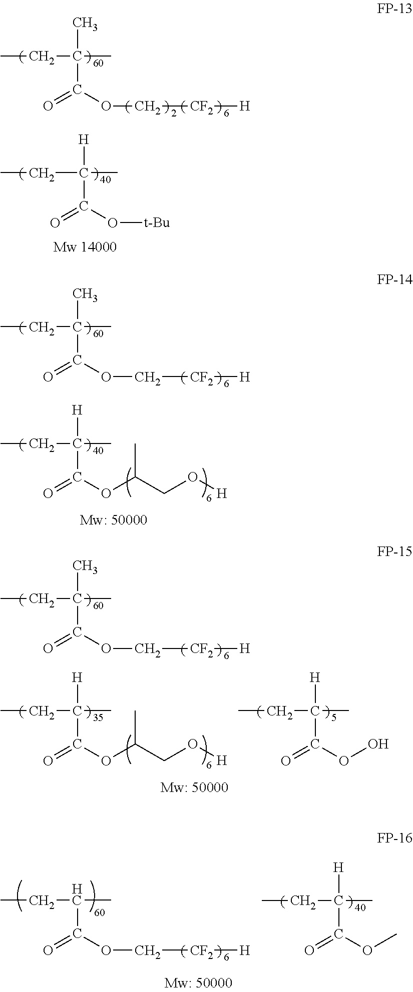

Furthermore, even when the thickness of the antistatic hard coat layer was changed to 2 μm to 20 μm in any of the optical films of the examples, the same results of the example of the present invention were obtained.

In addition, even in a case where a cellulose triacetate film (TDH80UF) with a thickness of 80 μm or a cellulose triacetate film (T40UZ) with a thickness of 40 μm (the above manufactured Fuji Film Holdings Corporation, refractive index 1.48) was used as the optical film instead of the cellulose triacetate film with a thickness of 60 μm as the transparent support in any of the examples, the same results as the examples of the present invention were obtained.

Furthermore, the interference roughness and the surface roughness were evaluated as below. The results are shown in table 5.

(4) Interference Roughness

After the rear surface of the optical film described in table 5 were coated using a black marker pen, the front surface of the optical film was observed under a 3-wavelength fluorescent lamp which is attached to the front surface of the scattering plate. Evaluations of A and B are a pass in the evaluation criteria below.

A: Interference roughness are not recognized

B: Slight interference roughness are recognized but this is not a problem

C: Interference roughness are recognized and this is a problem

(5) Surface Roughness

The occurrence frequency (number) of the surface roughness such as coating roughness, wind roughness, dry roughness, and the like with transparent visual surface checking by irradiating with a fluorescent light from the rear surface side was checked with regard to 10 m² on the coating surface side (side where the antistatic hard coat layer is formed) and the number of surface roughness per 1 m² was calculated by dividing this value by 10.

A: Excellent surface with zero surface roughness

B: Surface roughness with frequency of less than 1 per 1 m² and the low frequency is not a problem

C: Surface roughness with frequency of 1 or more and less than 3 per 1 m² but this is not a problem in practice

D: Surface roughness with frequency of 3 or more per 1 m² and this is a problem in practice

Evaluations of A, B, and C are in a permissible range in the present invention.

TABLE 5

| | Interference | Surface | |
|---|---|---|---|
| Sample No. | Roughness | Roughness | Reference |
| No. 15 | Measurement | D | Comparative Example |
| | not possible | (Intense | |
| | | repellence) | |
| No. 21 | B | A | Example |
| No. 22 | C | B | Comparative Example |
| No. 23 | C | D | Comparative Example |
| No. 27 | A | A | Example |
| No. 29 | A | D | Comparative Example |
| No. 35 | A | B | Example |
| No. 36 | A | D | Comparative Example |
| No. 37 | A | C | Example |
| No. 39 | A | A | Example |
| No. 40 | A | A | Example |
| No. 42 | B | A | Example |
| No. 43 | B | C | Example |
| No. 54 | B | A | Example |
| No. 55 | B | A | Example |
| No. 56 | B | A | Example |
| No. 57 | B | A | Example |
| No. 58 | B | A | Example |
| No. 59 | B | A | Example |
| No. 60 | B | A | Example |

Since the coating solution which is coated on the transparent support was remarkably repelled in the sample 15 and the hard coat layer was not able to be formed, interference roughness were not able to be measured.

Preparation of Antireflection Film

Synthesis of Perfluoroolefin Copolymer P-1

A perfluoroolefin copolymer P-1 was prepared using the same method as the perfluoroolefin copolymer (1) described in JP2010-152311A. The refractive index of the obtained polymer was 1.422.

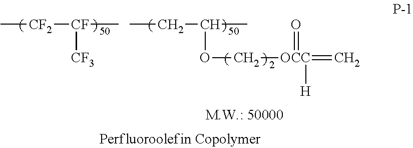

In the structural formula, 50:50 represents the molar ratio.

Preparation of Hollow Silica Dispersion Solution A-1

A hollow silica particle dispersion solution A-1 (solid content concentration of 18.2 mass %) where the average particle diameter was 60 nm, the shell thickness was 10 nm, and the refractive index of the silica particles was 1.31 was prepared by being adjusted with the conditions using the same method as the dispersion solution A-1 described in JP2007-298974A.

Preparation of Low Refractive Index Layer Forming Composition A-1

A low refractive index layer forming composition A-1 (solid content concentration of 5 mass %) was formed by putting the composition below into a mixing tank and stirring.

| | |
|---|---|
| Perfluoroolefin copolymer P-1 | 14.8 mass parts |
| Ethyl methyl ketone | 157.7 mass parts |
| DPHA | 3.0 mass parts |
| Hollow silica particle dispersion solution A-1 | 21.2 mass parts |
| Irgacure 127 | 1.3 mass parts |
| X22-164C | 2.1 mass parts |

The compound which are used are shown below.
DPHA: mixture of dipentaerythritol pentaacrylate and dipentaerythritol hexaacrylate (manufactured by Nippon Kayaku Co., Ltd.)
X22-164C: reactive silicon (manufactured by Shin-Etsu Chemical Co., Ltd.)
Irgacure 127: photopolymerization initiator (manufactured by Chiba Japan)

Preparation of Low Refractive Index Layer

An antireflection film sample No. 51 was obtained by coating the manufactured low refractive index layer forming composition A-1 using a gravure coater onto the hard coat layer of the optical film sample No. 10 which has the manufactured hard coat layer. The drying conditions were 90° C. and 30 seconds and the ultraviolet curing conditions were illumination of 600 mW/cm² and an irradiation amount of 600 mJ/cm² using a cooled metal halide lamp (manufactured by Eye Graphics Co., Ltd.) of 240 W/cm while purging the nitrogen so that there is an atmosphere where the oxygen concentration is 0.1% volume or less. The film thickness of the low refractive index layer was 95 nm.

Antireflection film sample Nos. 52 and 53 were obtained by coating the low refractive index layer forming composition A-1 in the same manner as the sample No. 51 on the hard coat layer of the samples Nos. 30 and 39 which have the prepared hard coat layer shown in table 6.

TABLE 6

| Antireflection film sample No. | Sample No. | Reference |
|---|---|---|
| No. 51 | No. 10 | Example |
| No. 52 | No. 30 | Example |
| No. 53 | No. 39 | Example |

Specular Reflectivity

Specular reflectivity with an emission angle of 5° at an incident angle of 5° was measured in a wavelength region of 380 to 780 nm by mounting an adaptor ARV-474 in a spectrophotometer V-550 (manufactured by Jasco Corporation), the average reflectivity at 450 to 650 nm was calculated, and the antireflection properties were evaluated. The results are shown in table 7.

Dust Attachment Preventing Properties

The transparent support side of the antireflection film was attached to an LCD display and was used for 24 hours in a room where dust and fragments of tissue paper which were 0.5 pm or more were 100 to 2000000 per 1 ft³ (cubic feet) under conditions of 22° C. and 43% RH. The number of pieces of dust and tissue paper fragment which were attached were measured per 100 cm² of the antireflection film and each of the results were evaluated as below as the average values.

A: At less than 20, hardly any dust was attached

B: Small amount of dust was attached at 20 or more and less than 200 but this is not a problem

C: At more than 200, large amount of dust was attached

TABLE 7

| | | Dust | | | | |
|---|---|---|---|---|---|---|
| Film | Specular | attachment | | | | |
| Sample | Reflec- | preventing | Log | Pimple | Pencil | |
| No. | tivity | properties | SR | defects | hardness | Reference |
| No. 10 | 4.10% | A | 9.2 | A | 2.7H | Example |
| No. 30 | 4.10% | B | 10.0 | A | 2.8H | Example |
| No. 39 | 4.10% | A | 8.6 | A | 2.3H | Example |
| No. 51 | 1.22% | A | 9.2 | A | 2.7H | Example |
| No. 52 | 1.22% | B | 10.0 | A | 2.8H | Example |
| No. 53 | 1.22% | A | 8.6 | A | 2.3H | Example |

As shown in table 7, in the sample Nos. 51 to 53 where the low refractive index layer was formed on the hard coat layer, the specular reflectivity is lowered to the vicinity of 1.20% and imparting of excellent antireflective properties is possible. Furthermore, it is understood that excellent antistatic properties (dust attachment preventing properties), suppressing of pimple defects, and pencil hardness can be achieved in the same manner as when the low refractive index layer is not formed. In addition, the same effects can be obtained even in a case where the optical film in any of the examples is used instead of the film samples in table 7 as the optical film which has the hard coat layer where the low refractive index layer is formed on the hard coat layer.

Saponification Process of Optical Film

The process below was performed on the film sample No. 10.

A sodium hydroxide aqueous solution was prepared to be 1.5 mol/l and kept at 55° C. A dilute sulfuric acid aqueous solution was prepared to be 0.01 mol/l and kept at 35° C. After the manufactured optical film is immersed for 2 minutes in the sodium hydroxide aqueous solution, there was immersion in water and the sodium hydroxide aqueous solution was sufficiently washed. Next, after being immersed in the dilute sulfuric acid aqueous solution for 1 minute, there was immersion in water and the dilute sulfuric acid aqueous solution was sufficiently washed. The sample was finally sufficiently dried at 120° C.

In this manner, the optical film where the saponification process has been completed was manufactured.

Preparation of Polarization Plate

A triacetyl cellulose film (TAC-TD8OU, manufactured by Fuji Film Holdings Corporation) with a thickness of 80 μm which was neutralized and washed after being immersed in an NaOH aqueous solution of 1.5 mol/l at 55° C. for 2 minutes and an optical film where the saponification process has been completed were attached to and protects both sides of the polarization elements which is manufactured by absorbing iodine in polyvinyl alcohol and stretching to obtain a polarization plate (sample No. 71).

In addition, the polarization plate sample Nos. 72 to 74 were manufactured in the same manner other than the fact that the film sample No. 10 was changed to the antireflection film sample Nos. 51 to 53.

Preparation of Circularly Polarizing Plate

Circularly polarizing plates (sample Nos. 81 to 84) were manufactured by adhering a λ/4 plate to the surface on the opposite side to the hard coat layer or the low refraction index layer of the polarization plate sample and the sample Nos. 81 to 84 were adhered to the organic EL display using an adhesion agent so that the hard coat layer or the low refraction index layer is an outer side. Excellent display preference was obtained so that there are no bright points due to the pimple defects, hardly any dust is attached, and there are no surface roughness. In addition, the same effect can be obtained even in a case where any of the optical films of the examples are used instead of the sample No. 10 as the optical film.

Excellent display preference was obtained so that there are no bright points due to the pimple defects, hardly any dust is attached, and there are no surface roughness when the sample Nos. 81 to 84 where the hard coat layer or the low refraction index layer is an outer side as the polarization plate were used on the surface of a reflection-type liquid crystal display or a semi-transparent-type liquid crystal display. In addition, the same effect can be obtained even in a case where polarization plate having any of the optical films of the examples are used instead of the sample No. 10 as the optical film in the polarization plate.

### Example 2

Preparation of Hollow Silica Dispersion Solution B-1

With regard to 500 parts of the hollow silica dispersion solution A-1 which is prepared in example 1, after 15 parts of acryloyloxy propyl trimethoxysilane and 1.5 parts of di-isopropoxy aluminum ethyl acetate were added and mixed, 9 parts of ion-exchanged water was added. The mixture was cooled to room temperature after reacting for 8 hours at 60° C. and 1.8 parts of acetyl acetone was added. While MI BK (methyl isobutyl ketone) was added so that the total solution amount is substantially uniform, the solvent was replaced using evaporation at reduced pressure. Finally, a dispersion solution B-1 was prepared by adjusting so that the solid content is 20%.

Preparation of Hollow Silica Dispersion Solution A-2

A hollow silica particle dispersion solution A-2 (solid content concentration of 18.2 mass %) where the average particle diameter was 50 nm, the shell thickness was 8 nm, and the refractive index of the silica particles was 1.30 was prepared by adjusting with the conditions using the same method as the dispersion solution A-1 described in JP2007-298974A.

Preparation of Hollow Silica Dispersion Solution B-2

With regard to 500 parts of the hollow silica dispersion solution (A-2), after 15 parts of acryloyloxy propyl trimethoxysilane and 1.5 parts of di-isopropoxy aluminum ethyl acetate were added and mixed, 9 parts of ion-exchanged water was added. The mixture was cooled to room temperature after reacting for 8 hours at 60° C. and 1.8 parts of acetyl acetone was added. While MI BK was added so that the total solution amount is substantially uniform, the solvent was replaced using evaporation at reduced pressure. Finally, a dispersion solution B-2 was prepared by adjusting so that the solid content is 20%.

Preparation of Hollow Silica Dispersion Solution A-3

A hollow silica particle dispersion solution A-3 (solid content concentration of 18.2 mass %) where the average particle diameter was 60 nm, the shell thickness was 7 nm, and the refractive index of the silica particles was 1.25 was prepared by adjusting with the conditions using the same method as the dispersion solution A-1 described in JP2007-298974A.

Preparation of Hollow Silica Dispersion Solution B-3

With regard to 500 parts of the hollow silica dispersion solution (A-3), after 15 parts of acryloyloxy propyl trimethoxysilane and 1.5 parts of di-isopropoxy aluminum ethyl acetate were added and mixed, 9 parts of ion-exchanged water was added. The mixture was cooled to room temperature after reacting for 8 hours at 60° C. and 1.8 parts of acetyl acetone was added. While MI BK was added so that the total solution amount is substantially uniform, the solvent was replaced using evaporation at reduced pressure. Finally, a dispersion solution B-3 was prepared by adjusting so that the solid content is 20%.

Preparation of Low Refractive Index Layer Coating Solution

Each of the components are mixed as shown in table 8, and after propylene glycol monomethyl ether acetate was added thereto, the solution obtained was diluted by using methyl ethyl ketone to prepare a low refractive index layer coating solution that the proportion of the propylene glycol monomethyl ether acetate was 30 mass % in the total solvent and the solid content concentration was 5 mass %. After being put into a glass separation flask with a mixer, low refractive index layer coating solutions L-1 to L15 were obtained by filtering using a depth filter made from polystyrene with hole diameters of 0.5 μm after the 1 hour stirring at room temperature. Here, in table 8, the added amount of each component represents “mass %” with regard to the total solid content of the composition.

TABLE 8

| Low | | | | | | | | |
|---|---|---|---|---|---|---|---|---|
| refractive | Multifunctional | | Inorganic fine | | | | Antifouling | |
| index layer | polymer | | particles | | Initiator | | agent | |
| composition | Type | Amount | Type | Amount | Type | Amount | Type | Amount |
| L-1 | A-TMMT | 73.5 | B-1 | 20 | Irg. 127 | 3 | X22-164E | 3.5 |
| L-2 | A-TMMT | 63.5 | B-1 | 30 | Irg. 127 | 3 | X22-164E | 3.5 |
| L-3 | A-TMMT | 62.5 | B-1 | 30 | Irg. 127 | 3 | X22-164E | 4.5 |
| L-4 | A-TMMT | 61.5 | B-1 | 30 | Irg. 127 | 3 | X22-164E | 5.5 |
| L-5 | A-TMMT | 53.5 | B-1 | 40 | Irg. 127 | 3 | X22-164E | 3.5 |
| L-6 | A-TMMT | 43.5 | B-1 | 50 | Irg. 127 | 3 | X22-164E | 3.5 |
| L-7 | A-TMMT | 43.5 | B-1 | 50 | Irg. 127 | 3 | X22-164C | 3.5 |
| L-8 | DPHA | 48.5 | B-1 | 45 | Irg. 127 | 3 | RMS-033 | 3.5 |
| L-9 | DPHA | 48.5 | B-1 | 45 | Irg. 127 | 3 | X22-164C | 3.5 |
| L-10 | DPHA | 48.5 | B-2 | 45 | Irg. 127 | 3 | X22-164C | 3.5 |
| L-11 | DPHA | 48.5 | B-3 | 45 | Irg. 127 | 3 | X22-164C | 3.5 |
| L-12 | PET-30 | 49.0 | B-1 | 45 | Irg. 127 | 3 | RMS-033 | 3 |
| L-13 | PET-30 | 49.0 | B-2 | 45 | Irg. 127 | 3 | X22-164C | 3 |
| L-14 | PET-30 | 49.0 | B-2 | 45 | Irg. 184 | 3 | X22-164C | 3 |
| L-15 | PET-30 | 49.0 | B-2 | 45 | Irg. 907 | 3 | X22-164C | 3 |

The compounds which were used in each are shown below.
PET-30: mixture of pentaerythritol triacrylate and pentaerythritol tetra acrylate (manufactured by Nippon Kayaku Co., Ltd.)
X22-164E: reactive silicon (manufactured by Shin-Etsu Chemical Co., Ltd.)
RMS-033: reactive silicon (manufactured by Gelest, Inc.)
Irg. 907: photopolymerization initiator, Irgacure 907: photopolymerization initiator (manufactured by Chiba Japan)

Preparation of Low Refractive Index Layer

Antireflection film samples were manufactured by combining the optical film sample Nos. 1 to 3, 5 to 8, 10, 12, 16, 17, 20, 21, 24, 25, 27, 28, 30 to 33, 35, 37, 39, 40, 42, 43, and 54 to 66 which were manufactured in example 1 with all of the low refractive index layer forming compositions in table 8. The manufacturing conditions of the low refractive index layers were the same as the antireflection film sample No. 51 other than the fact that the combination of the optical films and the low refractive index layer forming compositions and that the film thickness was 90 nm.

As a result of these antireflection films being evaluated in the same manner as the example 1, it was understood that excellent antireflection properties, antistatic properties (dust attachment preventing properties), suppressing of pimple defects, and pencil hardness can be achieved.

This application claims priority under 35 U.S.C. §119 of Japanese Patent application JP 2011-190171, filed on Aug. 31, 2011, Japanese Patent application JP 2012-062739, filed on Mar. 19, 2012, Japanese Patent application JP 2012-104199, filed on Apr. 27, 2012, and Japanese Patent application JP 2012-182687, filed on Aug. 21, 2012, the entire contents of which are hereby incorporated by reference.

What is claimed is:

1. An antistatic hard coat layer forming composition comprising:
a nonvolatile component which contains
(a) a conductive polymer where the weight average molecular weight is 20,000 to 500,000,
(b) a compound which has no hydroxyl group and has two or more photo-polymerizable groups, and
(c) a photo-polymerization initiator; and
a volatile component which contains
(d) a solvent which has a hydroxyl group, and
(e) a solvent having no hydroxyl group where the boiling point is 120° C. or less,
wherein the solvent (d) which has a hydroxyl group includes a solvent (d2) with 4 or more carbon atoms, having a hydroxyl group, where the boiling point is 90° C. or more, and the SP value is 22.0 or more and 35.0 or less,
a proportion of the conductive polymer (a) in the nonvolatile component of the composition is 1 to 20 mass %,
a proportion of the solvent (d) in the volatile component of the composition is 0.5 to 25 mass %, and
a proportion of the solvent (d2) in the solvent (d) is 80 to 100 mass %.

2. The antistatic hard coat layer forming composition according to claim 1,
wherein the solvent (d2) is a secondary alcohol or a tertiary alcohol.

3. The antistatic hard coat layer forming composition according to claim 2,
wherein the solvent (d2) is a solvent which has a carbonyl group.

4. The antistatic hard coat layer forming composition according to claim 3,
wherein the solvent (d2) is a diacetone alcohol.

5. The antistatic hard coat layer forming composition according to claim 1,
wherein the conductive polymer (a) is an ion-conducting polymer.

6. The antistatic hard coat layer forming composition according to claim 5,
wherein the conductive polymer (a) is a quaternary ammonium salt-containing polymer.

7. The antistatic hard coat layer forming composition according to claim 1,
wherein the proportion of the compound (b) in the nonvolatile component of the composition is 60 mass % or more.

8. The antistatic hard coat layer forming composition according to claim 1,
wherein the proportion of the solvent (e) in the volatile component of the composition is 40 mass % or more.

9. The antistatic hard coat layer forming composition according to claim 1,
wherein the concentration of the nonvolatile component of the composition is 40 mass % or more.

10. The antistatic hard coat layer forming composition according to claim 1, further comprising:
a poly ethylene oxide compound (f) which has one or more photo-polymerizable groups, has no hydroxyl group, and has a —(CH₂CH₂O)ₖ— structure (k represents a number of 1 to 50),
wherein the proportion of the compound (f) in the nonvolatile component of the composition is 1 to 20 mass %.

11. An optical film comprising:
an antistatic hard coat layer which is formed from the antistatic hard coat layer forming composition according to claim 1 on a transparent base material.

12. The optical film according to claim 11, further comprising:
a low refractive index layer on the antistatic hard coat layer where a refractive index of the low refractive index layer is lower than that of the antistatic hard coat layer.

13. The optical film according to claim 11,
wherein the transparent base material is a cellulose acylate film.

14. The optical film according to claim 11,
wherein the transparent base material is a (meth)acrylic-based resin film.

15. A polarization plate using the optical film according to claim 11 as a polarization plate protection film.

16. An image display device comprising:
the optical film according to claim 11.

17. An image display device comprising:
the polarization plate according to claim 15.

18. An optical film manufacturing method comprising:
forming an antistatic hard coat layer by coating the antistatic hard coat layer forming composition according to claim 1 on a transparent base material and curing the coated composition.
